(19) United States
(12) Patent Application Publication
(10) Pub. No.: US 2026/0112264 A1
(43) Pub. Date: Apr. 23, 2026

(54) PATIENT SUPPORT APPARATUS COMMUNICATION SYSTEM

(71) Applicant: Stryker Corporation, Portage, MI (US)

(72) Inventors: Celso Henrique Farnese Pires Pereira, Portage, MI (US); Anas Najjar, Sicklerville, NJ (US); Lavanya Vytla, Prosper, TX (US); Krishna Sandeep Bhimavarapu, Kalamazoo, MI (US); Jerald A. Trepanier, Augusta, MI (US)

(21) Appl. No.: 19/358,976

(22) Filed: Oct. 15, 2025

Related U.S. Application Data
(60) Provisional application No. 63/708,896, filed on Oct. 18, 2024.

(51) Int. Cl. G08B 26/00; A61G 7/05

(52) U.S. Cl. CPC G08B 26/008; A61G 7/0524; A61G 2203/20; A61G 2205/50

(57) ABSTRACT

A patient support apparatus may include a support surface, a nurse call interface, a nurse call control, a second control, and a controller. The nurse call interface communicatively couples to a multi-pin nurse call cable. The nurse call control calls a remote caregiver. The second control is adapted to be activated by a patient or locally-positioned caregiver. The controller changes an electrical state of a first pin of the cable in response to activation of the nurse call control and changes an electrical state of a second pin in response to activation of the second control. Alternatively, or additionally, the controller may change a dynamic label for the second control in response to a triggering condition, and/or communicate data with the nurse call system that defines whether activation of a particular control of the patient support apparatus will carry out a first or second function.

### CROSS-REFERENCE TO RELATED APPLICATIONS

This application claims priority to U.S. provisional patent application Ser. No. 63/708,896 filed Oct. 18, 2024, by inventors Celso Pereira et al. and entitled PATIENT SUPPORT APPARATUS COMMUNICATION SYSTEM, the complete disclosure of which is incorporated by reference herein.

### BACKGROUND

The present disclosure relates to patient support apparatuses, such as beds, cots, stretchers, recliners, or the like, which are adapted to communicate with an existing nurse call system.

Existing hospital beds often communicate with a nurse call system over a communication link. In some situations where the communication link is a wireless communication link, the hospital bed may communicate with a communication unit attached to a wall of a healthcare facility room. In such cases, the wall unit acts as an intermediary device between the bed and a wall outlet of the nurse call system. In other situations, the hospital bed may communicate directly with the wall outlet via a nurse call cable, thereby avoiding the need for a wall unit. In either case, the patient support apparatus is able to bidirectionally communicate with the patient support apparatus. Such bidirectional communication typically takes place over a multi-pin nurse call cable (coupled between the patient support apparatus and wall outlet, or between the wall unit and the wall outlet) wherein the pins of the cable are used for carrying out fixed and predefined functions.

### SUMMARY

According to various versions, the present disclosure provides an improved method and/or and system for communicating information between a patient support apparatus and a conventional nurse call system. The improved system and/or method allows patient support apparatuses to utilize the pins of the nurse call cable in dynamic manners and/or to utilize the pins for carrying out functions different from the predefined functions. In some versions, the system and/or method allow the patient support apparatus and/or a stationary unit to communicate data with each other the defines the function of one or more of the pins. The system and/or method therefore allow a broader and/or different amount of data to be communicated to/from a nurse call system than was previously possible. communicate over pins whose functions may dynamically change and/or over pins whose functions. These and other aspects of the present disclosure will be apparent to a person skilled in the art in light of the accompanying drawings and following description.

According to a first version of the present disclosure, a patient support apparatus is provided that includes a support surface, a nurse call interface, a nurse call control, a second control, and a controller. The support surface is adapted to support a patient thereon. The nurse call interface is adapted to communicatively couple to a multi-pin nurse call cable. The nurse call control is adapted to be activated by a patient of the patient support apparatus in order to call a remote caregiver. The second control is adapted to be activated by at least one of the patient or a nearby caregiver in order to carry out a function different from calling the remote caregiver. The controller is adapted to change an electrical state of a first pin of the multi-pin nurse call cable in response to activation of the nurse call control, and to change an electrical state of a second pin of the multi-pin nurse call cable in response to activation of the second control. The first pin is different from the second pin.

According to other aspects of the present disclosure, the patient support apparatus includes a label indicating the function of the second control.

In some aspects, the label is a dynamic label and the controller is adapted to change the dynamic label to indicate a different function for the second control.

The label, in some aspects, indicates that the second control is for at least one of the following: requesting a beverage, requesting ice, informing a caregiver the patient is in pain, indicating a code blue, indicating an IV is empty or nearing empty, requesting a cart, requesting an exam kit, informing the caregiver the patient needs to use the restroom, or requesting food.

In some aspects, the dynamic label is displayed on a touchscreen display.

The controller, in some aspects, is further adapted to communicate data over a third pin of the multi-pin nurse call cable with a nurse call system. The data indicates the function of the second control and the third pin is different from the first and second pins.

The controller, in some aspects, is adapted to transmit the data to the nurse call system.

In some aspects, the controller is adapted to receive the data from the nurse call system.

In some aspects, the controller is further adapted to communicate data over a third one of the pins with a nurse call system, and the data indicates which one of the pins corresponds to the second pin. The third pin is different from the first and second pins.

The nurse call interface, in some aspects, is adapted to electrically couple to a first end of the multi-pin nurse call cable, and a second end of the multi-pin nurse call cable is adapted to plug into a nurse call outlet defined in a room of a healthcare facility.

In some aspects, the patient support apparatus further includes a microphone, and the controller is adapted to direct audio signals from the microphone to a third pin of the multi-pin nurse call cable. The third pin is different from both the first and second pins.

The dynamic label, in some aspects, indicates the function of the second control, and the controller is adapted to change the dynamic label to indicate different functions of the second control in response to a triggering condition.

The triggering conditions, in some aspects, includes at least one of the following: a relocation of the patient support apparatus to a different location in the healthcare facility; a time of day; a day of the week; a day of the year; a diagnosis of the patient; a presence of a nearby caregiver; or an absence of a nearby caregiver.

The controller, in some aspects, is adapted to communicate with the nurse call system via serial communication over the third pin.

The patient support apparatus, in some aspects, is adapted to direct audio signals from the microphone to a fourth pin of the multi-pin nurse call cable. The fourth pin is different from the first, second, and third pins.

In some aspects, the patient support apparatus further includes a sensor adapted to detect a state of a component of the patient support apparatus, and the controller is further adapted to change an electrical state of a third pin of the multi-pin nurse call cable in response to the component changing from a first state to a second state.

In some aspects, the sensor is part of an exit detection system and the controller is adapted to change the electrical state of the third pin in response to the exit detection system detecting a patient exit.

The sensor, in some aspects, includes at least one of a siderail, a brake, or a lift, and the controller is adapted to change the electrical state of the third pin in response to at least one of the siderail, brake, or lift changing from the first state to the second state.

The second control, in some aspects, is one of a button, a switch, or an icon on a touchscreen.

The nurse call interface, in some aspects, includes a wireless transceiver adapted to communicate with a stationary unit. The stationary unit is physically coupled to the multi-pin nurse call cable, and the nurse call interface is communicatively coupled to the multi-pin nurse call cable via the stationary unit.

In some aspects, the nurse call interface is physically coupled to the multi-pin nurse call cable.

According to other aspects of the present disclosure, a patient support apparatus is provided that includes a support surface, a nurse call interface, a control, a dynamic label, and a controller. The support surface is adapted to support a patient thereon. The nurse call interface is adapted to communicatively couple to a multi-pin nurse call cable. The control is adapted to be activated by at least one of the patient or a caregiver. The dynamic label is adapted to indicate a first function of the control. The controller is adapted to change an electrical state of a first pin of the multi-pin nurse call cable in response to activation of the control. The controller is also adapted to change the dynamic label to indicate a second function of the second control in response to a triggering condition, wherein the second function is different from the first function.

According to still other aspects of the present disclosure, the triggering condition includes at least one of the following: a relocation of the patient support apparatus to a different location in the healthcare facility; a time of day; a day of the week; a day of the year; a diagnosis of the patient; a presence of a nearby caregiver; or an absence of a nearby caregiver.

In some aspects, the second function includes at least one of the following: requesting a beverage, requesting ice, informing a caregiver the patient is in pain, indicating a code blue, indicating an IV is empty or nearing empty, requesting a cart, requesting an exam kit, informing the caregiver the patient needs to use the restroom, or requesting food.

The dynamic label, in some aspects, is displayed on a touchscreen display.

The nurse call interface, in some aspects, is adapted to electrically couple to a first end of the multi-pin nurse call cable, and a second end of the multi-pin nurse call cable is adapted to plug into a nurse call outlet defined in a room of a healthcare facility.

The patient support apparatus, in some aspects, further includes a microphone, and the controller is adapted to direct audio signals from the microphone to a second pin of the multi-pin nurse call cable. The second pin is different from the first pin.

In some aspects, the patient support apparatus includes a sensor adapted to detect a state of a component of the patient support apparatus, and the controller is further adapted to change an electrical state of a second pin of the multi-pin nurse call cable in response to the component changing from a first state to a second state.

The sensor, in some aspects, is part of an exit detection system and the controller is adapted to change the electrical state of the second pin in response to the exit detection system detecting a patient exit.

In some aspects, the sensor includes at least one of a siderail, a brake, or a lift, and the controller is adapted to change the electrical state of the second pin in response to at least one of the siderail, brake, or lift changing from the first state to the second state.

The control, in some aspects, is one of a button, a switch, or an icon on a touchscreen.

The patient support apparatus, in some aspects, includes a nurse call control adapted to be activated by a patient of the patient support apparatus when the patient wishes to call a remote caregiver, and the controller is adapted to change an electrical state of a second pin of the multi-pin nurse call cable in response to activation of the nurse call control. The second pin is different from the first pin.

The controller, in some aspects, is adapted to communicate data over a third pin of the multi-pin nurse call cable with a nurse call system. The data defines the second function of the control, and the third pin is different from the first and second pins.

In some aspects, the controller is adapted to transmit the data to the nurse call system.

In some aspects, the controller is adapted to receive the data from the nurse call system.

The controller, in some aspects, is adapted to communicate data over a third one of the pins with a nurse call system, wherein the data indicates which one of the multiple pins corresponds to the first pin. The third pin is different from the first and second pins.

The patient support apparatus, in some aspects, includes a microphone, and the controller is adapted to direct audio signals from the microphone to a third pin of the multi-pin nurse call cable. The third pin is different from the first and second pins.

The controller, in some aspects, is adapted to communicate with the nurse call system via serial communication over a fourth pin of the multi-pin nurse call cable. The fourth pin is different the first, second, and third pins.

The controller, in some aspects, is adapted to communicate data defining the second function of the control via serial communication over the fourth pin.

The nurse call interface, in some aspects, includes a wireless transceiver adapted to communicate with a stationary unit. The stationary unit is physically coupled to the multi-pin nurse call cable, and the nurse call interface is communicatively coupled to the multi-pin nurse call cable via the stationary unit.

The nurse call interface, in some aspects, is physically coupled to multi-pin nurse call cable.

According to still other aspects of the present disclosure, a patient support apparatus is provided that includes a support surface, a nurse call interface, a control, and a controller. The support surface is adapted to support a patient thereon. The nurse call interface is adapted to communicatively couple to a multi-pin nurse call cable. The control is adapted to be activated by at least one of the patient or a caregiver in order to carry out either a first function or a second function different from the first function. The controller is adapted to change an electrical state of a first pin of the multi-pin nurse call cable in response to activation of the control. The controller is further adapted to communicate data with the nurse call system defining whether activation of the control will carry out the first function or the second function.

According to other aspects of the present disclosure, the controller is adapted to transmit the data to the nurse call system.

In some aspects, the controller is adapted to receive the data from the nurse call system.

In some aspects, the data is communicated over a second pin of the multi-pin nurse call cable. The second pin is different from the first pin.

In some aspects, the data is communicated over the first pin prior to the control being activated.

The data, in some aspects, is communicated serially over the multi-pin nurse call cable.

In some aspects, the patient support apparatus further includes a dynamic label adapted to indicate the first function in response to the data indicating activation of the control will carry out the first function, and to indicate the second function in response to the data indicating activation of the control will carry out the second function.

The control, in some aspects, is further adapted to carry out a third function different from the first and second function in response to a triggering condition.

The triggering condition may include at least one of the following: a relocation of the patient support apparatus to a different location in the healthcare facility; a time of day; a day of the week; a day of the year; a diagnosis of the patient; a presence of a nearby caregiver; or an absence of a nearby caregiver.

In some aspects, the second function includes at least one of the following: requesting a beverage, requesting ice, informing a caregiver the patient is in pain, indicating a code blue, indicating an IV is empty or nearing empty, requesting a cart, requesting an exam kit, informing the caregiver the patient needs to use the restroom, or requesting food.

The dynamic label, is some aspects, is displayed on a touchscreen display.

The nurse call interface, in some aspects, is adapted to electrically couple to a first end of the multi-pin nurse call cable. A second and opposite end of the multi-pin nurse call cable is adapted to plug into a nurse call outlet defined in a room of a healthcare facility.

In some aspects, the patient support apparatus further includes a microphone, and the controller is adapted to direct audio signals from the microphone to a second pin of the multi-pin nurse call cable. The second pin is different from the first pin.

The patient support apparatus, in some aspects, further includes a sensor adapted to detect a state of a component of the patient support apparatus, and the controller is further adapted to change an electrical state of a second pin of the multi-pin nurse call cable in response to the component changing from a first state to a second state.

The sensor, in some aspects, is part of an exit detection system and the controller is adapted to change the electrical state of the second pin in response to the exit detection system detecting a patient exit.

The sensor, in some aspects, includes at least one of a siderail, a brake, or a lift, and the controller is adapted to change the electrical state of the second pin in response to at least one of the siderail, brake, or lift changing from the first state to the second state.

The control, in some aspects, is one of a button, a switch, or an icon on a touchscreen.

The patient support apparatus, in some aspects, further includes a nurse call control adapted to be activated by a patient of the patient support apparatus when the patient wishes to call a remote caregiver. The controller is adapted to change an electrical state of a second pin of the multi-pin nurse call cable in response to activation of the nurse call control. The second pin is different from the first pin.

In some aspects, the patient support apparatus further includes a microphone, and the controller is adapted to direct audio signals from the microphone to a third pin of the multi-pin nurse call cable. The third pin is different from the first and second pins.

The nurse call interface, in some aspects, includes a wireless transceiver adapted to communicate with a stationary unit. The stationary unit is physically coupled to the multi-pin nurse call cable, and the nurse call interface is communicatively coupled to the multi-pin nurse call cable via the stationary unit.

In some aspects, the nurse call interface is physically coupled to multi-pin nurse call cable.

According to other aspects of the present disclosure, a patient support apparatus is provided that includes a support surface, a nurse call interface, a first control, a second control, and a controller. The support surface is adapted to support a patient thereon. The nurse call interface is adapted to communicatively couple to a multi-pin nurse call cable. The first control is adapted to be activated by at least one of the patients or a caregiver in order to carry out a first function. The second control is adapted to be activated by at least one of the patient or the caregiver in order to carry out a second function different from the first function. The controller is adapted to change an electrical state of a first pin of the multi-pin nurse call cable in a first manner in response to activation of the first control, and to change the electrical state of the first pin in a second manner in response to activation of the second control. The first manner is different from the second manner.

According to other aspects of the present disclosure, the first function includes at least one of the following: requesting a beverage, requesting ice, informing a caregiver the patient is in pain, indicating a code blue, indicating an IV is empty or nearing empty, requesting a cart, requesting an exam kit, informing the caregiver the patient needs to use a restroom, or requesting food.

In some aspects, the first manner includes generating a first sequence of voltage changes on the first pin and the second manner includes generating a second sequence of voltage changes on the first pin. The first sequence is different from the second sequence.

In some aspects, the nurse call interface is adapted to electrically couple to a first end of the multi-pin nurse call cable, and a second end of the multi-pin nurse call cable is adapted to plug into a nurse call outlet defined in a room of a healthcare facility.

The patient support apparatus, in some aspects, includes a microphone, and the controller is adapted to direct audio signals from the microphone to a second pin of the multi-pin nurse call cable. The second pin is different from the first pin.

In some aspects, the patient support apparatus further includes a sensor adapted to detect a state of a component of the patient support apparatus, and the controller is further adapted to change an electrical state of a second pin of the multi-pin nurse call cable in response to the component changing from a first state to a second state.

The sensor, in some aspects, is part of an exit detection system and the controller is adapted to change the electrical state of the second pin in response to the exit detection system detecting a patient exit.

The sensor, in some aspects, includes at least one of a siderail, a brake, or a lift, and the controller is adapted to change the electrical state of the second pin in response to at least one of the siderail, brake, or lift changing from the first state to the second state.

In some aspects, the first and second controls are each one of a button, a switch, or an icon on a touchscreen.

In some aspects, the nurse call interface includes a wireless transceiver adapted to communicate with a stationary unit. The stationary unit is physically coupled to the multi-pin nurse call cable, and the nurse call interface is communicatively coupled to the multi-pin nurse call cable via the stationary unit.

In some aspects, the nurse call interface is physically coupled to the multi-pin nurse call cable.

According to still other aspects of the present disclosure, a stationary unit is provided that is adapted to carry out wireless communication with a patient support apparatus in a healthcare facility. The stationary unit includes a nurse call interface, a wireless transceiver, and a controller. The nurse call interface is adapted to communicatively couple to a multi-pin nurse call cable. The wireless transceiver is adapted to communicate with the patient support apparatus. The controller is adapted to communicate data with the nurse call system defining whether changing an electrical state of a first pin of the multi-pin nurse call cable will carry out a first function or a second function. The data is communicated via the multi-pin nurse call cable. The controller is further adapted to send a message to the patient support apparatus via the wireless transceiver indicating whether changing the electrical state of the first pin will carry out the first function or the second function.

In some aspects, the controller is adapted to change the electrical state of the first pin in response to receipt of a second message from the patient support apparatus.

The nurse call interface, in some aspects, is physically coupled to multi-pin nurse call cable.

The controller, in some aspects, is adapted to transmit the data to the nurse call system.

The controller, in some aspects, is adapted to receive the data from the nurse call system.

The data, is some aspects, is communicated over a second pin of the multi-pin nurse call cable, and the second pin is different from the first pin.

The data, in some aspects, is communicated over the first pin prior to receipt of the second message.

The data, in some aspects, is communicated serially over the multi-pin nurse call cable.

In some aspects, the controller is adapted to direct audio signals received from the patient support apparatus to a second pin of the multi-pin nurse call cable. The second pin is different from the first pin.

The controller, in some aspects, is adapted to change an electrical state of a second pin of the multi-pin nurse call cable in response to receipt of a third message from the patient support apparatus indicating a component of the patient support apparatus has changed from a first state to a second state.

In some aspects, the controller is adapted to transmit a location identifier to the patient support apparatus, wherein the location identifier indicates a location of the stationary unit with the healthcare facility.

Before the various embodiments disclosed herein are explained in detail, it is to be understood that the claims are not to be limited to the details of operation or to the details of construction and the arrangement of the components set forth in the following description or illustrated in the drawings. The embodiments described herein are capable of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the claims to any specific order or number of components. Nor should the use of enumeration be construed as excluding from the scope of the claims any additional steps or components that might be combined with or into the enumerated steps or components.

### BRIEF DESCRIPTION OF THE DRAWINGS

FIG. 1 is a perspective view of a patient support apparatus according to a first version of the present disclosure;

FIG. 2 is a perspective view of a litter frame and a pair of lift header assemblies of the patient support apparatus;

FIG. 3 is a perspective view of a base and a pair of lifts of the patient support apparatus;

FIG. 4 is a diagram of the patient support apparatus, a wireless stationary unit, and a wireless communication link between the patient support apparatus and a wall outlet of a nurse call system;

FIG. 5 is a diagram of an alternative wireless stationary unit;

FIG. 6 is a block diagram of several of the structures of FIG. 4 showing some of the internal components of the stationary unit and the patient support apparatus;

FIG. 7 is a plan view of an illustrative patient control panel of the patient support apparatus, including a dynamic label;

FIG. 8 is an illustrative customization menu screen that may be displayed on a display of the patient support apparatus and/or on a display of another device;

FIG. 9 is a perspective view of a prior art 37-pin male cable connector;

FIG. 10 is a perspective view of a prior art 37-pin female cable connector; and

FIG. 11 is a chart of a prior art example of the functions of the pins of a 37-pin cable often used in existing healthcare facilities.

### DETAILED DESCRIPTION OF THE DISCLOSURE

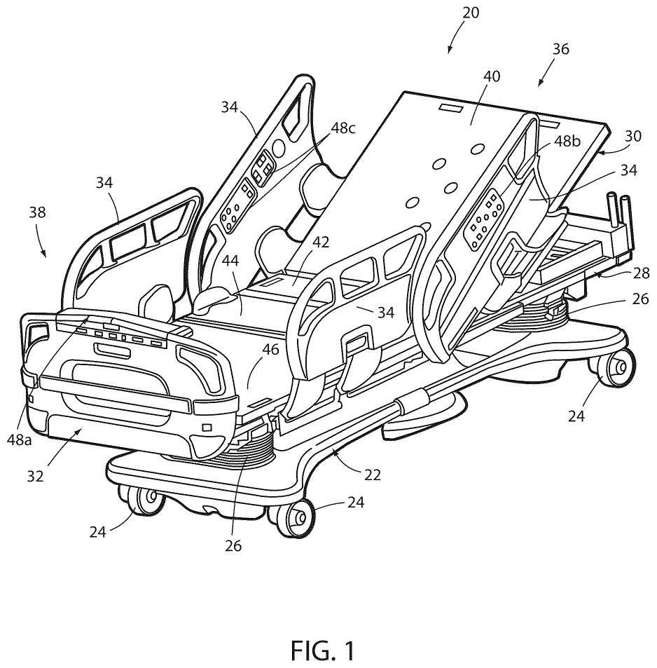

An illustrative patient support apparatus 20 according to a first version of the present disclosure is shown in FIG. 1. Although the particular form of patient support apparatus 20 illustrated in FIG. 1 is a bed adapted for use in a hospital or other medical setting, it will be understood that patient support apparatus 20 could, in different versions, be a cot, a stretcher, a recliner, a chair, or any other patient support structure that communicates with a nurse call outlet of a conventional nurse call system.

In general, patient support apparatus 20 includes a base 22 having a plurality of wheels 24, a pair of lifts 26 supported on the base 22, a litter frame 28 supported on the lifts 26, and a support deck 30 supported on the litter frame 28. Patient support apparatus 20 further includes a footboard 32 and a plurality of side rails 34. Side rails 34 are all shown in a raised position in FIG. 1 but are each individually movable to a lower position in which ingress into, and egress out of, patient support apparatus 20 is not obstructed by the lowered side rails 34.

Lifts 26 are adapted to raise and lower litter frame 28 with respect to base 22. Lifts 26 may be hydraulic actuators, pneumatic actuators, electric actuators, or any other suitable device for raising and lowering litter frame 28 with respect to base 22. In the illustrated version, lifts 26 are operable independently so that the tilting of litter frame 28 with respect to base 22 can also be adjusted. That is, litter frame 28 includes a head end 36 and a foot end 38, each of whose height can be independently adjusted by the nearest lift 26. Patient support apparatus 20 is designed so that when an occupant lies thereon, his or her head will be positioned adjacent head end 36 and his or her feet will be positioned adjacent foot end 38.

Litter frame 28 provides a structure for supporting support deck 30, footboard 32, and side rails 34. Support deck 30 provides a support surface for a mattress (not shown in FIG. 1), such as, but not limited to, an air, fluid, or gel mattress. Alternatively, another type of soft cushion may be supported on support deck 30 so that a person may comfortably lie and/or sit thereon. The top surface of the mattress or other cushion forms a support surface for the occupant.

Support deck 30 is made of a plurality of sections, some of which are pivotable about generally horizontal pivot axes. In the version shown in FIG. 1, support deck 30 includes a head section 40, a seat section 42, a thigh section 44, and a foot section 46. Head section 40, which is also sometimes referred to as a Fowler section, is pivotable about a generally horizontal pivot axis between a generally horizontal orientation (not shown in FIG. 1) and a plurality of raised positions (one of which is shown in FIG. 1). Thigh section 44 and foot section 46 may also be pivotable about generally horizontal pivot axes.

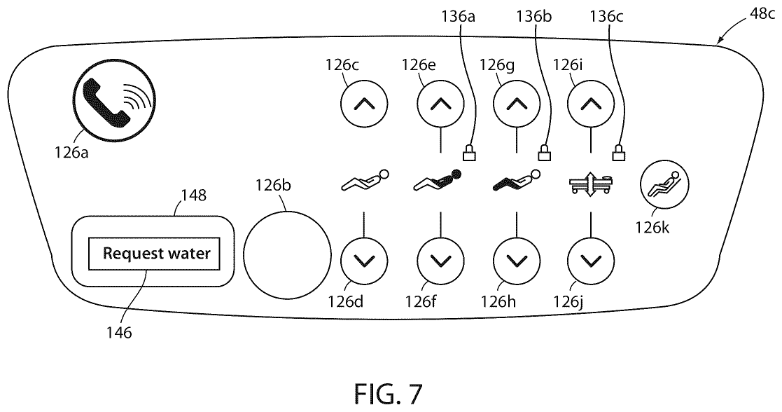

Patient support apparatus 20 further includes a plurality of control panels 48 that enable a user of patient support apparatus 20, such as a patient and/or an associated caregiver, to control one or more aspects of patient support apparatus 20. In the version shown in FIG. 1, patient support apparatus 20 includes a footboard control panel 48a, a pair of outer side rail control panels 48b (only one of which is visible), and a pair of inner side rail control panels 48c (only one of which is visible). Footboard control panel 48a and outer side rail control panels 48b are intended to be used by caregivers, or other authorized personnel, while inner side rail control panels 48c are intended to be used by the patient associated with patient support apparatus 20. Each of the control panels 48 includes a plurality of controls 126 (FIG. 7), although each control panel 48 does not necessarily include the same controls and/or functionality. FIG. 7 illustrates one example of a patient control panel 48c, although it will be understood that other types of patient control panels 48c may be used. Controls 126 may be implemented as buttons, switches, dials, pressure sensors, capacitive sensors, icons on a display, such as touchscreen, and/or in other manners.

Among other functions, the controls of control panel 48a (not shown) allow a user to control one or more of the following: change a height of litter frame 28, raise or lower head section 40, activate and deactivate a brake for wheels 24, arm and disarm an exit detection system, etc. One or both of the inner siderail control panels 48c may also include at least one nurse call control 126a (FIG. 7) that enables a patient to call a remotely located nurse (or other caregiver). In addition to the nurse call control 126a, one or both of the inner siderail control panels 48c also include one or more controls for controlling one or more features of one or more room devices positioned within the same room as the patient support apparatus 20. As will be described in more detail below, one or more of the controls may be dynamic controls whose function may be changeable.

Footboard control panel 48a is implemented in the version shown in FIG. 1 as a control panel having a lid (flipped down in FIG. 1) underneath which is positioned a plurality of controls. As with all of the controls of the various control panels 48, the controls of control panel 48a may be implemented as buttons, dials, switches, or other devices. Any of control panels 48a-c may also include a display for displaying information regarding patient support apparatus 20 and/or for displaying controls thereon. The display is a touchscreen in some versions.

In some versions, footboard control panel 48a may take on the form of the footboard control panel 54a disclosed in commonly assigned PCT patent application serial number PCT/US2021/32426 filed May 14, 2021, by applicant Stryker Corporation and entitled PATIENT SUPPORT APPARATUSES WITH HEADWALL COMMUNICATION, the complete disclosure of which is incorporated herein by reference. Additionally, or alternatively, patient control panel 48c may take on the form of the patient control panel 54c disclosed in the aforementioned PCT patent application. Other types of footboard control panels 48a-c may, of course, be implemented.

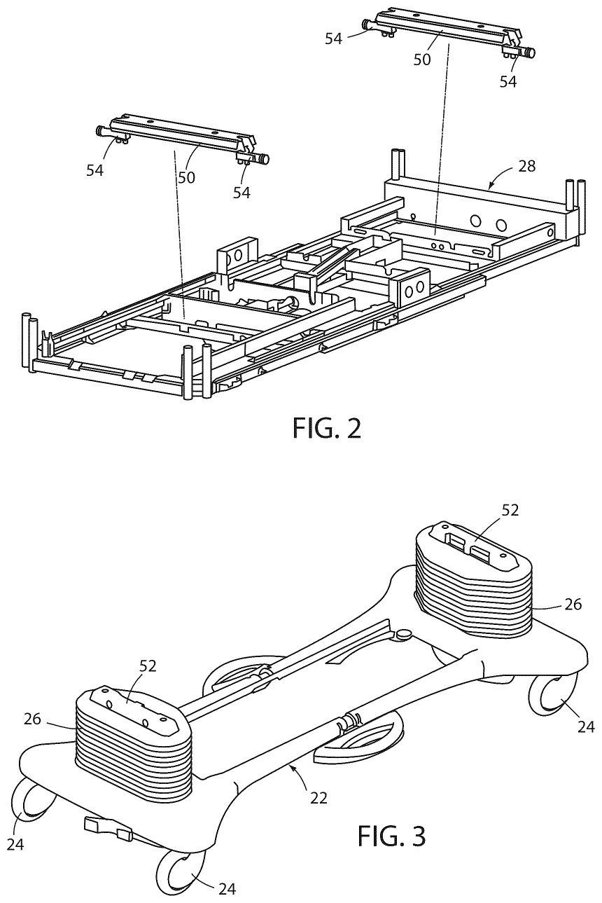

FIG. 2 illustrates in greater detail litter frame 28 separated from lifts 26 and base 22. Litter frame 28 is also shown in FIG. 2 with support deck 30 removed. Litter frame 28 is supported by two lift header assemblies 50. A first one of the lift header assemblies 50 is coupled to a top 52 (FIG. 3) of a first one of the lifts 26, and a second one of the lift header assemblies 50 is coupled to the top 52 of the second one of the lifts 26. Each lift header assembly 50 includes a pair of force sensors 54, which will be described herein as being load cells, but it will be understood that force sensors 54 may be other types of force sensors besides load cells. The illustrated version of patient support apparatus 20 includes a total of four load cells 54, although it will be understood by those skilled in the art that different numbers of load cells may be used in accordance with the principles of the present disclosure. Load cells 54 are configured to support litter frame 28. More specifically, load cells 54 are configured such that they provide complete and exclusive mechanical support for litter frame 28 and all of the components that are supported on litter frame 28 (e.g. support deck 30, footboard 32, side rails 34, etc.). Because of this construction, load cells 54 are adapted to detect the weight of not only those components of patient support apparatus 20 that are supported by litter frame 28 (including litter frame 28 itself), but also any objects or persons who are wholly or partially being supported by support deck 30.

The mechanical construction of patient support apparatus 20, as shown in FIGS. 1-3, may be nearly the same as the mechanical construction of the Model 3002 S3 bed manufactured and sold by Stryker Corporation of Kalamazoo, Michigan. This mechanical construction is described in greater detail in the Stryker Maintenance Manual for the MedSurg Bed, Model 3002 S3, published in 2010 by Stryker Corporation of Kalamazoo, Michigan, the complete disclosure of which is incorporated herein by reference. It will be understood by those skilled in the art that patient support apparatus 20 can be designed with other types of mechanical constructions, such as, but not limited to, those described in commonly assigned, U.S. Pat. No. 7,690,59 issued to Lemire et al., and entitled HOSPITAL BED; commonly assigned U.S. Pat. Publication No. 2007/0163045 filed by Becker et al. and entitled PATIENT HANDLING DEVICE INCLUDING LOCAL STATUS INDICATION, ONE-TOUCH FOWLER ANGLE ADJUSTMENT, AND POWER-ON ALARM CONFIGURATION; and/or commonly assigned, U.S. Pat. No. 10,130,536 to Roussy et al., entitled PATIENT SUPPORT USABLE WITH BARIATRIC PATIENTS, the complete disclosures of all of which are also hereby incorporated herein by reference. The mechanical construction of patient support apparatus 20 may also take on forms different from what is disclosed in the aforementioned references.

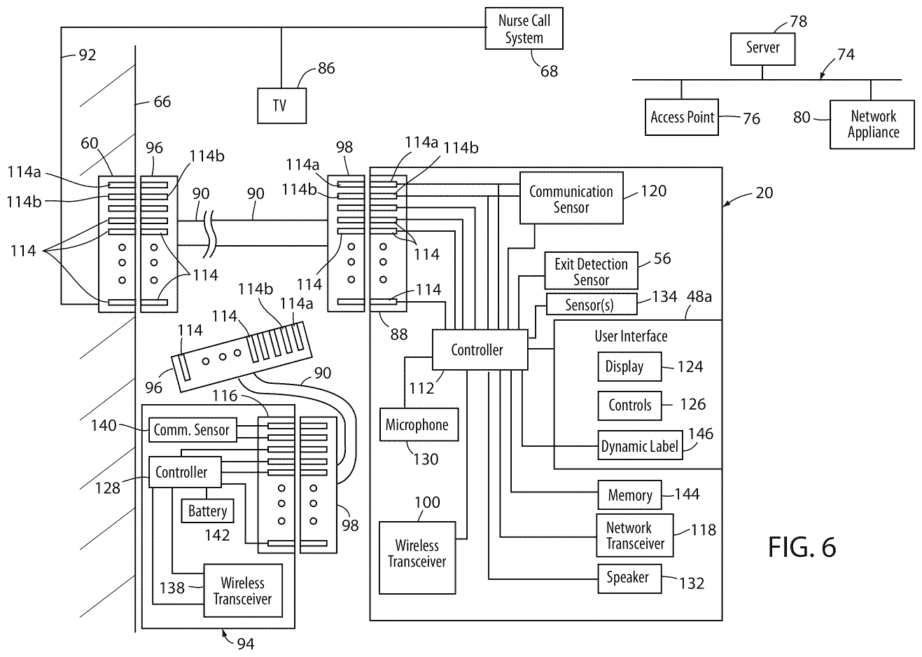

Load cells 54 are part of an exit detection system 56 (FIG. 6) that, when armed, issues an alert when the patient exits from patient support apparatus 20. Exit detection system 56 is adapted to be armed via control panel 48a. After being armed, exit detection system 56 determines when an occupant of patient support apparatus 20 has left, or is likely to leave, patient support apparatus 20, and issues an alert and/or notification to appropriate personnel so that proper steps can be taken in response to the occupant's departure (or imminent departure) in a timely fashion. In at least one version, exit detection system 56 monitors the center of gravity of the patient using the system and method disclosed in commonly assigned U.S. Pat. No. 5,276,432 issued to Travis and entitled PATIENT EXIT DETECTION MECHANISM FOR HOSPITAL BED, the complete disclosure of which is incorporated herein by reference. In other versions, exit detection system 56 determines if the occupant is about to exit, or already has exited, from patient support apparatus 20 by determining a distribution of the weights detected by each load cell 54 and comparing the detected weight distribution to one or more thresholds. In such versions, the center of gravity may or may not be explicitly calculated.

Other manners for functioning as an exit detection system are also possible. These include, but are not limited to, any of the manners disclosed in the following commonly assigned patent applications: U.S. patent application Ser. No. 14/873,734 filed Oct. 2, 2015, by inventors Marko Kostic et al. and entitled PERSON SUPPORT APPARATUS WITH MOTION MONITORING; U.S. patent publication 2016/0022218 filed Mar. 13, 2014, by inventors Michael Hayes et al. and entitled PATIENT SUPPORT APPARATUS WITH PATIENT INFORMATION SENSORS; and U.S. patent application Ser. No. 15/266,575 filed Sep. 15, 2016, by inventors Anuj Sidhu et al. and entitled PERSON SUPPORT APPARATUSES WITH EXIT DETECTION SYSTEMS, the complete disclosures of all of which are incorporated herein by reference. Further, in some versions, load cells 54 may be part of both an exit detection system and a scale system that measures the weight of a patient supported on support deck 30. The outputs from the load cells 54 are processed, in some versions, in any of the manners disclosed in commonly assigned U.S. patent application Ser. No. 62/428,834 filed Dec. 1, 2016, by inventors Marko Kostic et al. and entitled PERSON SUPPORT APPARATUSES WITH LOAD CELLS, the complete disclosure of which is incorporated herein by reference.

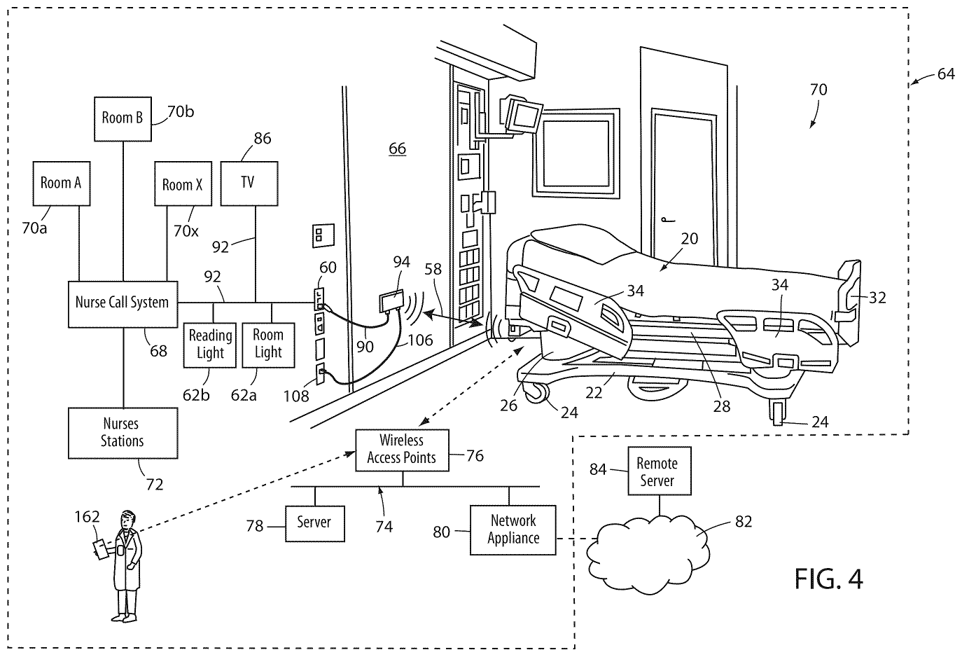

Regardless of how implemented, patient support apparatus 20 is adapted to communicate an alert when the exit detection system is armed and detects that a patient is about to, or has, exited. One manner in which the alert is communicated to a conventional nurse call system 68 is shown in FIG. 4. In the particular example shown in FIG. 4, patient support apparatus 20 communicates with a nurse call system 68, and vice versa, through a communication link 58 that is established between patient support apparatus 20 and a conventional nurse call wall outlet 60. In the example shown in FIG. 4, communication link 58 is a wireless communication link, but it will be understood that communication link 58 may be wired (i.e., a cable). In addition to forwarding an exit detection alert over communication link 58 from patient support apparatus 20 to nurse call system 68, communication link 58 may be used for communicating a variety of other information, as will be discussed in greater detail below.

One example of such information are the audio signals of the patient and a remotely positioned nurse. That is, a patient onboard patient support apparatus 20 is able to communicate with a remotely positioned nurse by speaking into a microphone 130 onboard patient support apparatus 20, and patient support apparatus 20 forwards these audio signals to a remotely positioned nurse by transmitting them over communication link 58 to wall outlet 60, which is in communication with nurse call system 68, as will be discussed in greater detail below. Similarly, a remotely positioned nurse is able to speak into a microphone coupled to the nurse call system 68 and have his/her voice signals forwarded to wall outlet 60, which are then transmitted over communication link 58 to a speaker 132 onboard patient support apparatus 20.

FIG. 4 illustrates additional details of a typical healthcare facility 64. As shown therein, healthcare facility 64 includes a headwall 66, nurse call system 68, a plurality of rooms 70 (70a, 70b . . . 70x), one or more nurses' stations 72, a local area network 74, one or more wireless access points 76, a patient support apparatus server 78, and one or more network appliances 80 that couple LAN 74 to the internet 82, thereby enabling server 78 and other applications on LAN 74 to communicate with computers outside of healthcare facility 64, such as, but not limited to, a geographically remote server 84. Wall outlet 60 is typically electrically coupled by one or more conductors 92 to a television 86 and one or more room devices (e.g. a room light 62a, a reading light 62b, etc.). It will be understood by those skilled in the art, however, that the healthcare facility infrastructure shown in FIG. 4 may vary widely from healthcare facility to healthcare facility.

For example, patient support apparatus 20 may be used in healthcare facilities having no wireless access points 76, no connection to the internet 82 (e.g. no network appliances 80), and/or no patient support apparatus server 78. Still further, local area network 74 may include other and/or additional servers installed thereon, and/or room 70, in some healthcare facilities 64, may be semi-private room having multiple patient support apparatuses 20 and multiple wall outlets 60. Still other variations are possible. It will therefore be understood that the particular healthcare facility infrastructure shown in FIG. 4 is merely illustrative, and that patient support apparatus 20 is constructed to be communicatively coupled to healthcare facility communication infrastructures which are arranged differently from that of FIG. 4, some of which are discussed in greater detail below.

As is shown in FIG. 4, patient support apparatus 20 is adapted to be communicatively coupled to the wall outlet 60 on headwall 66 by way of wireless communication link 58 that wirelessly couples patient support apparatus 20 to a wireless stationary unit 94. Stationary unit 94, in turn, is coupled by way of a cable 90 to wall outlet 60. Stationary unit 94 and patient support apparatus 20 are able to communicate wirelessly with each other in a bidirectional fashion. That is, messages can be wirelessly sent from patient support apparatus 20 to stationary unit 94, and messages can be wirelessly sent from stationary unit 94 to patient support apparatus 20.

Although not shown in FIG. 4, patient support apparatus 20 may further be configured to be able to communicate with wall outlet 60 via a cable, if desired. When such wired communication is desired, a nurse call cable 90 is connected directly from patient support apparatus 20 to wall outlet 60. Unless wall outlet 60 has room for two cable plugs, the end of cable 90 shown in FIG. 4 that is plugged into wall outlet 60 is removed in order to allow the cable from patient support apparatus 20 to be inserted therein. Alternatively, the end of the cable 90 shown in FIG. 4 that is plugged into stationary unit 94 may be removed and plugged into patient support apparatus 20. However attained, once a cable 90 is coupled between patient support apparatus 20 and wall outlet 60, a wired connection is established that bypasses stationary unit 94 (if present).

Wall outlet 60 is coupled to one or more conventional conductors 92 that electrically couple the wall outlet 60 to nurse call system 68 and to one or more other devices, such as television 86, room light 62a, and/or reading light 62b. Conductors 92 are typically located behind headwall 66 and not visible. In some healthcare facilities, conductors 92 may first couple to a room interface board that includes one or more electrical connections electrically coupling the room interface board to television 86 and/or nurse call system 68. Still other communicative arrangements for coupling wall outlet 60 to nurse call system 68 and television 86 are possible.

Communication link 58 (FIG. 4) enables patient support apparatus 20 to communicate with nurse call system 68, television 86, room light 62a, and/or reading light 62b. A patient supported on patient support apparatus 20 who activates nurse call control 126a on patient support apparatus 20 causes a signal to be conveyed via communication link 58 to the nurse call system 68, which then sends a notification to one or more remotely located nurses (e.g. nurses at one of the nurses' stations 72). If the patient uses a TV control (not shown) positioned on one of the control panels 48 to change a channel or change the volume of television 86, the control conveys a signal along link 58 to the wall outlet 60, and the signal is thereafter passed from outlet 60 to television 86. Similarly, if the patient uses a room light or reading light control on one of the control panels 48, he or she is able to turn on or off the room light 62a and reading light 62b.

As will be discussed in greater detail below, outlet 60 often includes a plurality of pins (e.g. 37 pins), and the audio signals that are passed between the patient and a remotely positioned nurse are transmitted over a separate set of pins than the pins that transmits control signals for controlling television 86. Additional pins are used for communicating other information between patient support apparatus 20 and nurse call system 68 and/or other devices positioned within room 70 (e.g. television 86, room light 62a, reading light 62b).

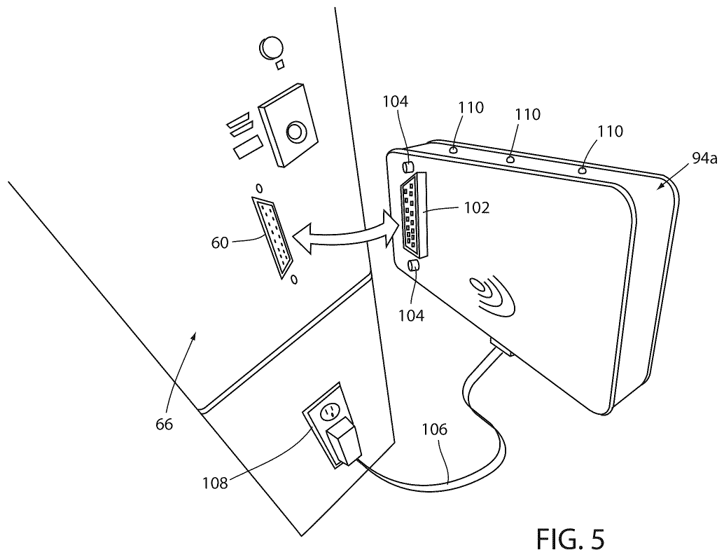

FIG. 5 illustrates an alternative version of a stationary unit 94a according to another version of the present disclosure. Stationary unit 94a differs from stationary unit 94 in that, rather than including a connector for cable 90 to plug into outlet 60, it is adapted to plug directly into wall outlet 60 via a connector 102 without using a cable 90. Connector 102 is thus shaped and dimensioned to be frictionally maintained in an electrically coupled state to outlet 60, and to support the entire stationary unit 94a. One or more alignment posts 104 may be included with connector 102 in order to more securely retain stationary unit 94a to wall outlet 60, if desired. Connector 102 may be the same as, or nearly the same as, an end of a cable 90, thereby allowing either a cable from stationary unit 94, or connector 102 from stationary unit 94a, to be inserted into wall outlet 60.

In the version shown in FIG. 5, connector 102 is a 37-pin connector that includes 37 pins adapted to be inserted into 37 mating sockets of wall outlet 60. Such 37 pin connections are one of the most common types of connectors found on existing headwalls of medical facilities for making connections to the nurse call system 68. Such 37 pin connectors, however, are not the only type of connectors, and it will be understood that stationary unit 94a can utilize different types of connectors 102 (whether integrated therein or attached to a cable) that are adapted to electrically couple to different types of nurse call outlets 60. One example of such an alternative wall outlet 60 and cable is disclosed in commonly assigned U.S. patent application Ser. No. 14/819,844 filed Aug. 6, 2015, by inventors Krishna Bhimavarapu et al. and entitled PATIENT SUPPORT APPARATUSES WITH WIRELESS HEADWALL COMMUNICATION, the complete disclosure of which is incorporated herein by reference. Still other types of wall outlets 60 and corresponding cable connectors 102 may be utilized.

Other than the absence of a connector for a cable 90, stationary unit 94a may be the same as stationary unit 94, and the following description of stationary unit 94 will apply equally to both stationary unit 94 and stationary unit 94a. Stationary unit 94 of FIG. 4 (and stationary unit 94a of FIG. 5) include a power cable 106 having an end adapted to be inserted into a conventional electrical outlet 108. Power cable 106 enables stationary unit 94 to receive power from the mains electrical supply via outlet 108. It will be appreciated that, in some versions, stationary unit 94 is battery operated and cable 106 may be omitted. In still other versions, stationary unit 94 may be both battery operated and include cable 106 so that in the event of a power failure, battery power supplies power to stationary unit 94, and/or in the event of a battery failure, electrical power is received through outlet 108.

Stationary unit 94 may also include a plurality of status lights 110, such as are shown in FIG. 5. Status lights 110 provide visual indications about one or more aspects of stationary unit 94. For example, in some versions, the illumination of one of status lights 110 indicates that stationary unit 94 is in successful communication with nurse call system 68 and/or patient support apparatus 20. The illumination of one or more additional status lights 110 may also or alternatively indicate that power is being supplied to stationary unit 94 and/or the status of a battery included within stationary unit 94. Still further, in some versions, one or more of status lights 110 may be illuminated depending upon whether a nurse is talking to the patient, or vice versa.

Stationary unit 94 of FIG. 4 (and stationary unit 94a of FIG. 5) are adapted to wirelessly receive signals from patient support apparatus 20 and deliver the signals to wall outlet 60 in a manner that matches the way the signals would otherwise be delivered to wall outlet 60 if a conventional nurse call cable (e.g. cable 90) were connected between patient support apparatus 20 and wall outlet 60. In other words, patient support apparatus 20 and stationary unit 94 cooperate to provide signals to wall outlet 60 in a manner that is transparent to wall outlet 60 and nurse call system 68 such that these components cannot detect whether they are in communication with patient support apparatus 20 via wired or wireless communication. In this manner, a healthcare facility can utilize the wireless communication abilities of one or more patient support apparatuses 20 without having to make any changes to their existing wall outlet 60 or to their nurse call system 68.

In addition to sending signals received from patient support apparatus 20 to wall outlet 60, stationary unit 94 is also adapted to forward signals received from wall outlet 60 to patient support apparatus 20. Such bidirectional communication includes, but is not limited to, communicating audio signals between a person supported on patient support apparatus 20 and a nurse positioned remotely from patient support apparatus 20 (e.g. nurses' station 72). The audio signals received by stationary unit 94 from patient support apparatus 20 are forwarded to wall outlet 60, and the audio signals received by wall outlet 60 from nurse call system 68 are forwarded to one or more speakers onboard patient support apparatus 20.

Stationary unit 94 also communicates the data and signals it receives from patient support apparatus 20 to appropriate pins 114 of wall outlet 60 (FIG. 6). Likewise, it communicates the data and signals it receives and/or detects on the pins 114 of wall outlet 60 to patient support apparatus 20 via wireless messages. The wireless messages include sufficient information for patient support apparatus 20 to discern what pins 114 the messages originated from, or sufficient information for patient support apparatus 20 to decipher the information included in the message. In at least one version, stationary unit 94 includes any and/or all of the same functionality as, and/or components of, the headwall units 76 disclosed in commonly assigned U.S. patent application Ser. No. 16/215,911 filed Dec. 11, 2018, by inventors Alexander Bodurka et al. and entitled HOSPITAL HEADWALL COMMUNICATION SYSTEM, the complete disclosure of which is incorporated herein by reference. Alternatively, or additionally, stationary unit 94 may include any and/or all of the same functionality as, and/or components of, the headwall interface 38 disclosed in commonly assigned U.S. patent publication 2016/0038361 published Feb. 11, 2016, entitled PATIENT SUPPORT APPARATUSES WITH WIRELESS HEADWALL COMMUNICATION, and filed by inventors Krishna Bhimavarapu et al., the complete disclosure of which is also incorporated herein by reference. Still further, stationary unit 94 and/or patient support apparatus 20 may include any of the functionality and/or components of the headwall units 140, 140a and/or patient support apparatuses 20, 20a, and/or 20b disclosed in commonly assigned U.S. patent application Ser. No. 62/833,943 filed Apr. 15, 2019, by inventors Alexander Bodurka et al. and entitled PATIENT SUPPORT APPARATUSES WITH NURSE CALL AUDIO MANAGEMENT, the complete disclosure of which is incorporated herein by reference.

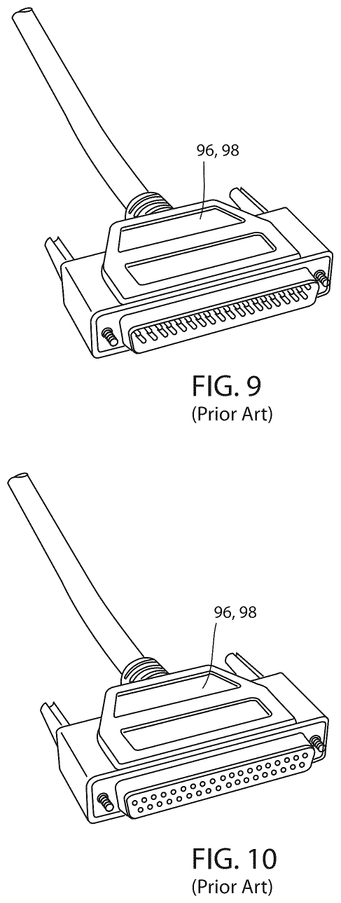

Cable 90 includes a first end having a first connector 96 and a second end having a second connector 98 (FIG. 6). First connector 96 is adapted to be plugged into wall outlet 60. Second connector 98 is adapted to be plugged into a nurse call interface 88 built into patient support apparatus 20. In many healthcare facilities 64, wall outlet 60 is conventionally configured as a multi-pin receptacle adapted to receive a cable having multiple pin 114. In such facilities, cable 90 includes first and second connectors 96 and 98 having multiple pins (one of which may be a male connector and the other of which may be a female connector, although other combinations may be used). One example of a conventional male 37-pin connector 96, 98 that may be used as first or second connector 96 or 98 is shown in FIG. 9. One example of a conventional female 37-pin connector 96, 98 that may be used as first or second connector 96 or 98 is shown in FIG. 10. Other types of 37-pin connectors may also be used, depending upon the configuration of wall outlet 60. Still further, in some healthcare environments, wall outlet 60 includes fewer pins 114 and/or has an arrangement of pins 114 that is shaped to match a cable 90 having connectors different from what is shown in FIGS. 9 and 10. Patient support apparatus 20 and stationary unit 94 are adapted to communicate with all of these different types of wall outlets 60 via an appropriately selected cable (e.g. one with the proper connectors 96, 98 on its ends).

FIG. 6 illustrates further details regarding the manner in which patient support apparatus 20 communicates with wall outlet 60, and vice versa, as well as the structures involved with that communication. In the example of FIG. 6, patient support apparatus 20 has dual communication capabilities. That is, it is able to communicate with wall outlet 60 via either wireless communication link 58 or cable 90.

Patient support apparatus 20 includes nurse call interface 88 (FIG. 6), a wireless transceiver 100, a controller 112, a network transceiver 118, a communication sensor 120, exit detection system 56, microphone 130, speaker 132, a memory 144, one or more sensors 134, and one or more control panels 48 (only control panel 48a is shown in FIG. 6, but it will be understood that the functions discussed below may be applicable to any of the control panels 48a-c).

Nurse call interface 88 is adapted to electrically couple to the plurality of pins 114 of cable connector 98. It will be understood that, although FIG. 6 shows a plurality of pins 114 for each of connectors 96 and 98 of cables 90, wall outlet 60, nurse call interface 88 of patient support apparatus 20, and a nurse call interface 116 of stationary unit 94, one or more of these devices (cable connectors 96, 98, interfaces 88, 116, and wall outlet 60) will include pin receptacles instead of pins 114. Such pin receptacles are adapted to receive and electrically couple to pins 114. Further, it will be understood that it does not matter which of these devices include pins and which includes pin receptacles so long as each connection between the devices include a combination of pins and pin receptacles that allow communication between the mated devices. Consequently, the term “pins” as used herein will refer to pins and/or pin receptacles.

In some versions, controller 112 is implemented as, and/or includes, one or more conventional microcontrollers. In other versions, controller 112 may be modified to use a variety of other types of circuits-either alone or in combination with one or more microcontrollers-such as, but not limited to, any one or more microprocessors, field programmable gate arrays, systems on a chip, volatile or nonvolatile memory, discrete circuitry, and/or other hardware, software, or firmware that is capable of carrying out the functions described herein, as would be known to one of ordinary skill in the art. Such components can be physically configured in any suitable manner, such as by mounting them to one or more circuit boards, or arranging them in other manners, whether combined into a single unit or distributed across multiple units. The instructions followed by the microcontroller (if included) when carrying out the functions described herein, as well as the data necessary for carrying out these functions, are stored in a memory (e.g. memory 144) that is accessible to controller 112.

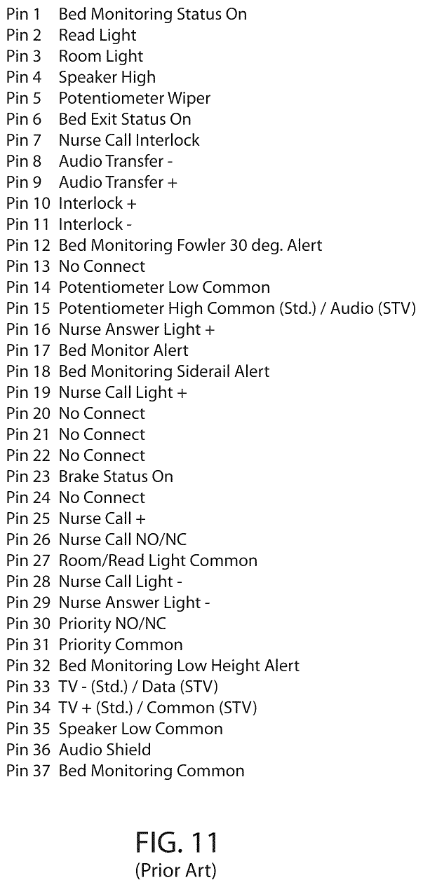

It will be understood that wall outlet 60, cables 90, and nurse call interfaces 88 and 116 are all illustrated in FIG. 6 as having only six pins. This is done merely for purposes of compact illustration. All of these components typically include 37 pins, although there are other wall outlets having different pin numbers and the principles of the present disclosure can be applied in healthcare facilities having these types of wall outlets as well. The pins that are not shown in FIG. 6 are used by other components of patient support apparatus 20 for other purposes, such as, but not limited to, any of the purposes illustrated in FIG. 11. For example, one or more pins may be used to convey information to a room light 62a or reading lights 62b that is electrically coupled to conductor 92, such as a message or command indicating that the patient has pressed a control on patient support apparatus 20 to turn on or turn off a light (62a or 62b) in the particular room in which patient support apparatus 20 is located. Another pin may communicate the status of a component onboard patient support apparatus 20, such as, but not limited to whether one or more side rails 34 are in a down position (or an up position); whether the position of any of the side rails 34 changes from an initial state; whether a brake on patient support apparatus 20 is set; whether the exit detection system is armed; whether support deck 30 is at its lowest height; whether head section 40 has pivoted to less than a threshold angle (e.g. 30 degrees); and whether patient support apparatus 20 has been set to monitor a particular set of conditions. These various items of data are detected by one or more corresponding sensors 134 onboard patient support apparatus 20 that are in communication with controller 112. Still others of the additional pins may be used for still other purposes.

Although FIG. 6 illustrates a number of the pins 114 of nurse call interface 88 being fed directly to controller 112, it will be understood that this is done merely for purposes of illustrative convenience, and that one or more of these pins 114 may be fed to one or more intermediary structures before being fed to controller 112. Such intermediary structures may include, but are not limited to, one or more relays and/or switches whose states are controlled by controller 112. Additionally, some pins 114 may not be coupled to controller 112, but may be routed to other structures within patient support apparatus 20.

It will also be understood that, although FIG. 6 illustrates two cables 90—one extending from patient support apparatus 20 to outlet 60 and another one extending from stationary unit 94 to a free end, in actual usage within a particular room within a healthcare facility, only a single cable 90 will be used at any given time. Thus, patient support apparatus 20 will either be coupled to outlet 60 by a cable 90, or stationary unit 94 will be coupled to outlet 60 by a cable 90. In the former case, patient support apparatus 20 communicates with wall outlet 60 via wired communication, and in the latter case, patient support apparatus 20 communicates with wall outlet 60 via wireless communication link.

Battery 122 supplies electrical power to patient support apparatus 20 when its power cord (not shown) is not plugged into an external source of electrical energy (e.g. electrical outlet 108 of FIG. 4). Controller 112, either alone or in combination with other circuitry, may be adapted to monitor a charge state of battery 122 and/or to monitor one or more other characteristics of battery 122. When so adapted, controller 112 is adapted to issue an alert if battery 122 drops below a particular charge threshold while patient support apparatus 20 is not coupled to an external source of electrical power.

Controller 112 (FIG. 6) communicates with communication sensor 120, exit detection system 56, control panel 48a, network transceiver 118, memory 144, battery 122, speaker 132, sensor(s) 134, nurse call interface 88, and wireless transceiver 100. Controller 112 uses wireless transceiver 100 to communicate wirelessly with stationary unit 94, and it uses nurse call interface 88 to communicate with wall outlet 60 via a cable 90.

In some versions, control panel 48a includes a display 124 (FIG. 6) and a plurality of controls 126. In some versions, the display 124 may take on the form and/or functionality of the display 64a disclosed in commonly assigned U.S. patent application Ser. No. 62/864,638 filed Jun. 21, 2019, by inventors Kurosh Nahavandi et al. and entitled PATIENT SUPPORT APPARATUS WITH CAREGIVER REMINDERS, the complete disclosure of which is incorporated herein by reference. Still other types of displays may also be used. Control panel 48a may also include a dashboard of the type disclosed in the aforementioned patent application. Still further, patient support apparatus 20 may be configured to issue any of the reminders in any of the manners disclosed in the aforementioned '638 patent application. Other types of control panels 48a, however, may alternatively be used.

Communication sensor 120 (FIG. 6) is adapted to detect when nurse call interface 88 is in communication with wall outlet 60 via a cable 90, and to report this information to controller 112. Further details of one manner in which communication sensor 120 may perform this function are set forth in commonly assigned U.S. patent application Ser. No. 18/561,457 filed May 24, 2022, by inventors Krishna Sandeep Bhimavarapu et al. and entitled PATIENT SUPPORT APPARATUS AND HEADWALL UNIT SYNCING, the complete disclosure of which is incorporated herein by reference.

In the version shown in FIG. 6, patient support apparatus 20 is also configured to communicate with wall outlet 60 in a wireless manner (e.g. without cable 90). This can be seen from the presence of wireless transceiver 100 on patient support apparatus 20. Wireless transceiver 100 may be a Bluetooth transceiver, an ultra-wideband transceiver, an infrared transceiver, or some other kind of wireless transceiver. In some versions of patient support apparatus 20, multiple wireless transceivers 100 may be included. As will be discussed in greater detail below, wireless transceiver 100 is used to establish a wireless communication link 58 with wall outlet 60 by wirelessly communicating with an adjacent stationary unit 94 that is coupled by a cable 90 to wall outlet 60.

FIG. 6 illustrates several internal components of stationary unit 94. These components include nurse call interface 116, a controller 128, a communication sensor 140, a battery 142, and a wireless transceiver 138. Wireless transceiver 138 is adapted to wirelessly communicate with wireless transceiver 100 of patient support apparatus 20. Accordingly, wireless transceiver 138 is the same type of transceiver as wireless transceiver 100, such as, but not limited to, a Bluetooth transceiver, an ultra-wideband transceiver, an infrared transceiver, etc.

Controller 128 communicates with communication sensor 140, transceiver 138, as well as with additional electronics that are present on stationary unit 94. The additional electronics may include any of the electronics disclosed in any of the following commonly assigned patent applications, and wireless stationary unit 94 may be configured to perform any of the functions disclosed in the following commonly assigned patent applications: Ser. No. 16/215,911 filed Dec. 11, 2018, by inventors Alexander Bodurka et al. and entitled HOSPITAL HEADWALL COMMUNICATION SYSTEM; Ser. No. 16/217,203 filed Dec. 12, 2018, by inventor Alexander Bodurka, and entitled SMART HOSPITAL HEADWALL SYSTEM; and Ser. No. 16/193,150 filed Nov. 16, 2018, by inventors Alexander Bodurka et al. and entitled PATIENT SUPPORT APPARATUSES WITH LOCATION/MOVEMENT DETECTION, the complete disclosures of both of which are incorporated herein by reference.

Wireless stationary unit 94 is coupled to a wall outlet 60 by way of cable 90 having a connector 96 that is adapted to be inserted into wall outlet 60. As was noted, in some versions, such as wireless stationary unit 94a of FIG. 5, cable 90 may be omitted and wireless stationary unit 94a may be inserted directly into wall outlet 60 by way of a connector 102. Further, as was noted previously, although FIG. 6 illustrates both a cable 90 coupling patient support apparatus 20 to wall outlet 60 and a cable 90 extending from stationary unit 94 to a free end, a typical room (or bay of a room) in a healthcare facility will only include a single cable 90 that, depending upon the presence or absence of stationary unit 94, will extend between patient support apparatus 20 and wall outlet 60, or between stationary unit 94 and wall outlet 60. Thus, the two different cables 90 of FIG. 6 illustrate two different options for setting up communications between patient support apparatus 20 and wall outlet 60.

Nurse call interface 116 of stationary unit 94 (FIG. 6) communicates with cable 90 in the same manners as nurse call interface 88 of patient support apparatus 20. That is, the signals on the various pins 114 of wall outlet 60 are communicated to controller 128 via cable 90 and nurse call interface 116, and controller 128 is adapted to forward those signals to wireless transceiver 100 of patient support apparatus 20 using transceiver 138. Likewise, wireless stationary unit 94 is adapted to receive data from patient support apparatus 20 via transceiver 138 and to forward the received data, as appropriate, to corresponding pins 114 of connector 98 of cable 90 (which are forwarded to wall outlet 60 when the opposite end (connector 96) of cable 90 is inserted in wall outlet 60).

In some versions, transceiver 138 of stationary unit 94 may also act as a location transceiver. In such versions, transceiver 138 sends a location code, or other location information, to patient support apparatus 20 that indicates the location of stationary unit 94 within the healthcare facility. In some versions, transceiver 138 may be a short range transceiver (e.g., an IR transceiver) that emits a short range signal containing an identifier that is unique to that particular wireless stationary unit and that can only be detected by patient support apparatus 20 when patient support apparatus 20 is positioned in close proximity to stationary unit 94. Patient support apparatus 20 may forward the location signal it receives from stationary unit 94 to an off-board server, such as server 78 and/or remote server 84, which contains a table correlating the unique identifiers of each stationary unit 94 to their location within the healthcare facility. This table is generated during a survey of the stationary units 94 when they are initially installed within the healthcare facility. Server 78 is therefore able to determine the location of each patient support apparatus 20 within the healthcare facility whenever the patient support apparatus 20 is positioned adjacent a stationary unit 94. Further explanation of one manner in which transceivers 100 and 138 may operate are provided in the following commonly assigned U.S. patent applications: Ser. No. 16/215,911 filed Dec. 11, 2018, by inventors Alexander Bodurka et al. and entitled HOSPITAL HEADWALL COMMUNICATION SYSTEM; Ser. No. 16/217,203 filed Dec. 12, 2018, by inventor Alexander Bodurka, and entitled SMART HOSPITAL HEADWALL SYSTEM; and Ser. No. 16/193,150 filed Nov. 16, 2018, by inventors Alexander Bodurka et al. and entitled PATIENT SUPPORT APPARATUSES WITH LOCATION/MOVEMENT DETECTION, the complete disclosures of all of which are incorporated herein by reference.

Transceivers 100 and 138 are used by controllers 112 and 128, respectively, to transmit audio signals between patient support apparatus 20 and wireless stationary unit 94, such as, but not limited to, the audio signals used to convey the voice signals of the patient and the remotely positioned nurse. Such audio signals may also include the audio signals from television 86 and/or a radio or other entertainment device positioned in the room 70. Wireless transceivers 100 and 138 may also be used to transmit other data, such as, but not limited to, status data regarding the status of patient support apparatus 20, one or more messages indicating an exit detection alert has been issued, and/or other data. In some versions, wireless stationary unit 94 and patient support apparatus 20 are configured to exchange audio signals therebetween in any of the manners disclosed in commonly assigned U.S. patent application Ser. No. 62/833,943 filed Apr. 15, 2019, by inventors Alexander Bodurka et al. and entitled PATIENT SUPPORT APPARATUSES WITH NURSE CALL AUDIO MANAGEMENT, the complete disclosure of which is incorporated herein by reference.

Communication sensor 140 of wireless stationary unit 94 operates in the same manner as communication sensor 120 of patient support apparatus 20. In some versions, communication sensor 140 is electrically coupled to the pins 114 corresponding to the Nurse Call Plus (+) and Priority Normally Open/Normally Closed (NO/NC) pins (see FIG. 11) and checks to see if a voltage is detected on either or both of these pins. If it detects a voltage on either or both of these pins, it concludes that connector 98 of cable 90 is coupled to both interface 116 and wall outlet 60. If it does not detect a voltage on at least one of these pins, it concludes that no cable 90 is coupling interface 116 to wall outlet 60. The detection, or lack of detection, of cable 90 may be reported to patient support apparatus 20 via patient support apparatus 20, which may display this information to a caregiver on control panels 48a, b, and/or c.

Network transceiver 118 (FIG. 6) is a wireless transceiver adapted to communicate with one or more wireless access points 76 of the healthcare facility's local area network 74. In some versions, transceiver 118 may be a WiFi transceiver adapted to transmit and receive wireless electrical signals using any of the various WiFi protocols (IEEE 802.11b, 801.11g, 802.11n, 802.11ac . . . , etc.). In other versions, network transceiver 118 may be a transceiver adapted to communicate using any of the frequencies, protocols, and/or standards disclosed in commonly assigned U.S. patent application Ser. No. 62/430,500 filed Dec. 6, 2016, by inventor Michael Hayes and entitled NETWORK COMMUNICATION FOR PATIENT SUPPORT APPARATUSES, the complete disclosure of which is incorporated herein by reference. In still other versions, transceiver 118 may be a wired transceiver that communicates with network 74 over a wired network, such as an Ethernet cable or the like. Regardless of whether transceiver 118 is a wired or wireless transceiver, it enables controller 112 to communicate with one or more servers on the healthcare facility's computer network 74, such as, but not limited to, patient support apparatus server 78.

Controller 112 uses network transceiver 118 to send messages to server 78 (and/or server 84) indicating the status patient support apparatus 20, stationary unit 94, and/or other information. Such status information includes data indicating whether patient support apparatus 20 is communicating via nurse call interface 88 or wireless transceiver 100, whether cable 90 is coupled between interface 88 and outlet 60, whether a cable is coupled between interface 116 and outlet 60, well as status data regarding battery 122 and/or 134, and other information. In some versions, server 78 and/or server 84 are configured to share this data with one or more other devices within the healthcare facility. For example, in at least one version, server 78 and/or server 84 are configured to transmit the communication status of patient support apparatus 20 to one more electronic devices 162 (FIG. 4), such as the electronic devices 104a and/or 104b disclosed in commonly assigned U.S. patent application Ser. No. 62/868,947 filed Jun. 30, 2019, by inventors Thomas Durlach et al. and entitled CAREGIVER ASSISTANCE SYSTEM, the complete disclosure of which is incorporated herein by reference. The electronic devices 162 may be smart phones, tablet computers, laptop computers, desktop computers, badges, tags, and/or other computing devices that are in communication with network 74 and therefore able to receive data from patient support apparatus server 78.

Memory 144 may be comprised of any one or more of the following: non-volatile flash memory, Random Access Memory (RAM), Read Only Memory (ROM), a mechanical hard drive, a solid-state hard drive, etc. Memory 144 may contain not only the instructions followed by controller 112 and the data used for carrying out those instructions, but also data defining the current status of one or more conditions, some of which may pertain to components onboard patient support apparatus 20 (e.g. exit detection system 56, siderails 34, etc.), and some of which may pertain to components off-board patient support apparatus 20 (e.g. room light 62a, reading light 62b, TV 86, nurse call system 68, and/or stationary unit 94).

FIG. 7 illustrates one example of a patient control panel 48c that may be incorporated into patient support apparatus 20 and positioned at a location on patient support apparatus 20 that is convenient for a patient to access while supported on support deck 30, such as on an interior side of one of the siderails 34. Control panel 48c includes a plurality of controls 126a-k that are generally intended to be operated by a patient, although a nearby caregiver or any other person within reach can operate these controls 126. Specifically, control panel 48c includes a nurse call control 126a, an assistance request control 126b, a combined Fowler and knee up control 126c, a combined Fowler and knee down control 126d, a Fowler up control 126e, a Fowler down control 126f, a knee up control 126g, a knee down control 126h, a height up control 126i, a height down control 126j, and a chair control 126k.

Nurse call control 126a, when pressed by the patient, sends a signal to the nurse call system 68 requesting that a remotely positioned nurse talk to the patient. Assistance request control 126b, when pressed by the patient, sends a signal to the nurse call system requesting that a remotely positioned caregiver perform a task, which, as discussed in more detail below, may vary. Assistance request control 126b, unlike nurse call control 126a, does not request, and lead to, a voice conversation with a remotely positioned nurse, but instead merely conveys a message to the remotely positioned caregiver of a particular need without sending any audio signals to or from the patient.

When a patient presses on combined controls 126c or 126d, controller 112 is configured to raise, or lower, both the knee section (i.e., the junction of thigh section 44 and foot section 46) and the Fowler section (i.e., head section 40) together. That is, if the patient presses on up control 126c, controller 112 is configured to activate both a Fowler actuator and a knee actuator such that both the Fowler section and the knee section are raised. If the patient presses on down control 126d, controller 112 is configured to activate both the Fowler actuator and the knee actuator such that both the Fowler section and the knee section are lowered.

When a patient presses on Fowler up control 126e or Fowler down control 126f, controller 112 is configured to raise or lower, respectively, the Fowler section 40 of support deck 30 by activating the corresponding Fowler actuator (now shown). When a patient presses on knee up control 126g or knee down control 126h, controller 112 is configured to raise or lower, respectively, the knee section of support deck 30 by activating the knee actuator. When a patient presses on height up control 126i or height down control 126j, controller 112 is configured to raise or lower, respectively, the height of litter frame 28 by activating lifts 26.

When a patient presses on chair control 126k, controller 112 is configured to control lifts 26, the Fowler actuator, and the knee actuator such that the overall configuration of support deck 30 and litter frame 28 is moved to positions and orientations that resemble a chair. In general, this involves pivoting the Fowler section to a raised orientation, lowering a foot section of support deck 30 to a lowered position and, in some versions, tilting litter frame 28 so that head end 36 is positioned higher than foot end 38.

In the example shown in FIG. 7, control panel 48c also includes a plurality of lockout indicators 136. Controller 112 illuminates these lockout indicators 136 when a caregiver has activated corresponding lockouts for these corresponding controls 126e-126j. Such lockout controls are typically found on one or more of the other caregiver control panels 48a and/or 48b. In response to a caregiver activating a lockout control, controller 112 is configured disable the control(s) 126 corresponding to the function that was locked out by the caregiver. And in order to let the patient know that the corresponding function is locked out, controller 112 illuminates the corresponding lockout indicator 136. Thus, if a caregiver has locked out movement of the Fowler section, controller 112 will illuminate lockout indicator 136a and ignore any presses of controls 126e or 126f.

Although not shown in FIG. 7, control panel 48c may include additional controls, such as one or more controls for communicating with television 86, a room light 62a, and/or a reading light 62b. Examples of such additional controls are shown in FIG. 7 of commonly assigned U.S. patent application Ser. No. 18/561,457 filed by inventors Krishna Bhimavarapu et al. on May 24, 2022, and entitled PATIENT SUPPORT APPARATUS AND HEADWALL UNIT SYNCING, the complete disclosure of which is incorporated herein by reference. Such additional controls 126 may include controls for turning the TV volume up/down, turning the TV channel up/down, turning the TV power on/off, turning the reading light on/off, and turning the room light on/off.

Control panel 48c, as shown in FIG. 7, also includes a dynamic label 146 positioned adjacent to assistance request control 126b. Dynamic label 146 may be displayed on a conventional display 148. In some versions, display 148 may be a touchscreen display. In other versions, display 148 may be a display for displaying electronic ink (e-ink), a conventional Liquid Crystal Display, or another type of display. As will be discussed in greater detail below, controller 112 may be configured to update the dynamic label 146 in response to one or more triggering conditions. The dynamic label 146 provides an indication to the patient of the function of assistance request control 126b. Thus, in those versions of patient support apparatus 20 in which dynamic label 146 is provided, the functionality of assistance request control 126b may change in response to one or more triggering conditions. In such versions, dynamic label 146 informs the patient of the current purpose of control 126b. It will, of course, be understood that not all versions of patient support apparatus 20 need to include dynamic label 146, and that not all versions of patient support apparatus 20 need to include an assistance request control 126b that changes. In some versions, assistance request control 126b carries out a function that remains static (i.e. does not change).

Patient support apparatus 20, in some versions, communicates one or more alerts, nurse call requests, assistance requests, status updates, and/or other data through nurse call interface 88 to wall outlet 60 by changing the state of one or more relays, or their electrical equivalent, which are in communication with different pairs of the pins 114. Thus, for example, if an exit alert is detected by exit detection system 56, controller 112 may change a state of a first relay from being open to being closed, or vice versa, wherein that first relay is in electrical communication with a pair of pins 114 in nurse call interface 88. Similarly, if a patient presses a nurse call control (e.g. control 126a) indicating his/her request to speak with a remotely positioned nurse via nurse call system 68, controller 112 may change the state of another relay (from open to closed, or vice versa) that is in electrical communication with another pair of pins 114 in nurse call interface 88. The same opening or closing of a corresponding relay may also occur in response to the patient activating a control 126 (not shown) on patient support apparatus 20 for turning on/off a room light 62, turning on/off a reading light 62b, and/or for controlling television 86. Still further, and as will be discussed in greater detail below, controller 112 may change the state of a relay, or an electronic equivalent, which is in electrical communication with a pair of pins 114 in response to a patient activating assistance request control 126b. Still further, in some versions of patient support apparatus 20, controller 112 may dynamically change which pins 114 have their electrical state changed in response to specific controls 126 being activated on patient support apparatus 20.

Stationary unit 94 (FIG. 6) may also contains a plurality of relays (not shown), or their electrical equivalent, which are in electrical communication with pairs of pins 114 in nurse call interface 116. Controller 128 controls the states of these relays based on messages received from patient support apparatus 20 via wireless transceiver 138. Thus, for example, if patient support apparatus 20 detects a patient exit and is configured to communicate that by opening or closing a first relay that electrically couples together pins 30 and 31, or another pair of pins, (see FIG. 11) of nurse call interface 88, it will send an exit detection alert message to stationary unit 94 via transceiver 138, and controller 128 of stationary unit 94 will react by opening or closing a first relay coupled to nurse call interface 116 that electrically couples together the same pair of pins 30 and 31 (or other pair of pins).

Similarly, if patient support apparatus 20 detects that a patient has activated nurse call control 126a, controller 112 of patient support apparatus 20 may open or close a second relay that electrically couples together pins 25 and 26, or another pair of pins, (see FIG. 11) of nurse call interface 88, and/or it will send a nurse call message to stationary unit 94 via transceiver 138, and controller 128 of stationary unit 94 will react by opening or closing the second relay coupled to nurse call interface 116 that electrically couples together the same pair of pins 25 and 26 (or other pair of pins).

If patient support apparatus 20 detects that a patient has activated assistance request control 126b, controller 112 of patient support apparatus 20 may open or close a third relay that electrically couples together another set of pins 114 (see FIG. 11) of nurse call interface 88, and/or it will send a nurse call message to stationary unit 94 via transceiver 138, and controller 128 of stationary unit 94 will react by opening or closing the third relay coupled to nurse call interface 116 that electrically couples together the same other set of pins 114. The particular pair of pins whose electrical state is changed in response to the assistance request control 126b being activated may vary in different versions and/or in different healthcare facilities. In some versions, the particular pair of pins may include any pair of pins whose function is not assigned in FIG. 11 (e.g. pins 20, 21, 22, 24), and/or it may include any pair of pins whose function is listed in FIG. 11, but which has been supplanted by the assistance request control 126b. That is, in some versions, any of the pins shown in FIG. 11 may have their assigned functions changed by patient support apparatus 20 to carry out the assistance request activated by control 126b.

A similar process happens for other events that occur on patient support apparatus 20, such as the reading light being turned on/off, the room light being turned on/off, and/or the TV being controlled. That is, whenever one of these actions occurs on patient support apparatus 20, controller 112 sends a corresponding message to stationary unit 94 that causes controller 128 to open/close a relay inside stationary unit 94. The relay that is opened/closed by controller 128 changes the electrical state of a pair of pins in nurse call interface 116, and the particular pair of pins whose electrical state is changed by this opening/closing of a relay are the same pair of pins whose electrical state controller 112 changes in nurse call interface 88. If stationary unit 94 is not present, controller 112 changes the electrical state of the corresponding pair of pins via nurse call interface 88 (which, in turn, should be coupled to nurse call outlet 60 by a cable 90).

In addition to changing the states of various relays, controller 128 of stationary unit 94 also monitors the states (i.e. voltages) on various pins 114 of nurse call interface 116 and sends messages to patient support apparatus 20 via transceiver 138 that inform patient support apparatus 20 of the states of these pins. Thus, for example, stationary unit controller 128 monitors a first pin 114 (or pair of pins 114) that is/are associated with a nurse call light. The nurse call light, in some versions, controls a backlight for control 126a that, when activated, changes a state of a backlight positioned behind control 126a. Alternatively, or additionally, the nurse call light may be positioned elsewhere on control panel 48c (FIG. 7), or at other locations on patient support apparatus 20.

In some versions, the voltage across pins 25 and 28 (FIG. 11) is associated with the state of the nurse call light, and controller 128 monitors this voltage to see what state the nurse call system 68 is indicating that the nurse call light should be in (on/off). The nurse call light is illuminated (or has its illumination state, such as its color, changed) when the patient presses nurse call control 126a to request to speak with a remotely positioned nurse, and the nurse call system 68 acknowledges receipt of this call. Notification of the activation of this control is sent to the nurse call system 68 via the opening/closing of a relay coupled to specific pins of wall outlet 60 (as discussed above), and the nurse call system 68, in response to successfully receiving this request, sends a signal back to the patient support apparatus 20 indicating that it should illuminate the nurse call light (or otherwise change its illumination state) as an acknowledgement by the nurse call system 68 that a call has been successfully placed. This response is communicated by changing the voltage across a pair of pins (e.g. pins 25 and 28 of FIG. 11). When controller 128 of stationary unit 94 detects a voltage across the nurse call request pins (25 and 28 of FIG. 11) of nurse call interface 116, it sends a message to patient support apparatus 20 (via transceiver 138) that causes controller 112 of patient support apparatus 20 to illuminate the nurse call light (or otherwise change its illumination state).

Controller 128 of stationary unit 94 (FIG. 6) also monitors the voltage between other pairs of pins 114 of nurse call interface 116 and reports, as appropriate, the state of this voltage to patient support apparatus 20 via transceiver 138. One such other pair of pins are pins 114 associated with a nurse call answer light (see, e.g. pins 16 and 29 of FIG. 11). A nurse call answer light is a light that the nurse call system 68 instructs the patient support apparatus 20 illuminate (or have its illumination state changed) when a nurse actually answers the patient's call. Thus, the nurse call answer light differs from the nurse call light in that the former is illuminated when the nurse answers a call while the latter is illuminated when the nurse call system 68 acknowledges that the call was placed.

When patient support apparatus 20 is coupled to wall outlet 60 via a cable 90, controller 112 of patient support apparatus 20 performs the same type of monitoring of the pins 114 of nurse call interface 88 that controller 128 does with respect to nurse call interface 116. In such situations, controller 112 takes the same actions that it does when stationary unit 94 sends it a message informing it of a change in the state of a particular pair of pins. For example, controller 112 of patient support apparatus 20 may monitor the voltage across pins 24 and 28 (FIG. 11) to determine whether or not to illuminate its nurse call light, as well as to monitor the voltage across pins 16 and 29 to determine whether or not to illuminate its nurse call answer light. Controller 112 reacts to changes in voltage across these pins in the same manner as it reacts to a wireless message from stationary unit 94 informing it of a similar change detected in the corresponding pins of nurse call interface 116. That is, controller 112 controls the illumination state of the nurse call light and/or the nurse call answer light in response to changes in the voltage across these pins.

It can therefore be seen that stationary unit 94 controls the voltages across various pins 114 in nurse call interface 116 (when patient support apparatus 20 is communicating wirelessly with wall outlet) in the same manner that patient support apparatus 20 controls the voltage across the corresponding pins 114 in nurse call interface 88 (when patient support apparatus 20 is communicating with wall outlet 60 via a cable 90). Similarly, stationary unit 94 monitors the voltage across various other pins 114 of nurse call interface 116 and sends messages to patient support apparatus 20 that cause patient support apparatus 20 to take the same actions that it would take in response to controller 112's detection of those same voltage changes on nurse call interface 88. Thus, nurse call interface 116 acts as a proxy for nurse call interface 88 when no cable is connected between patient support apparatus 20 and wall outlet 60.

Returning to FIG. 7, controller 112 of patient support apparatus 20 is adapted to send a signal to nurse call interface 88 in response to a patient activating assistance request control 126b. The signal instructs the nurse call interface 88 to change an electrical state between a pair of pins 114. The pair of pins whose electrical state is changed are different from the pair of pins whose electrical state are changed in response to nurse call control 126a being activated. In some versions, the pair of pins whose electrical state is changed in response to assistance request control 126b being activated are also different from the pair of pins whose electrical state are changed in response to exit detection system 56 detecting a patient exit, as well as the pairs of pins whose electrical state may be changed in response to another component of patient support apparatus 20 being in an undesired state (e.g., pin 23 and another pin 114 when the brake is not activated). That is, in some versions, the pair of pins whose electrical state is changed by nurse call interface 88 in response to the activation of assistance request control 126b may be pins 114 whose electrical state are never changed for any other reasons by nurse call interface 88 (i.e. they are exclusively changed in response to assistance request control 126b).

The changing of the electrical state of any of the pairs of pins 114 of nurse call interface 88 and nurse call interface 116 may involve the opening of a relay coupled to these pins 114, or it may involve the closing of a relay coupled to these pins 114, or it may involve changes in voltage between these pins, serial communication, and/or other types of changes in the electrical states.

The purpose of assistance request control 126b is indicated by a label, such as, but not limited to, dynamic label 146. In some versions of patient support apparatus 20, assistance request control 126b may be used by the patient to perform such functions as requesting water (or another beverage), requesting ice or ice chips, informing a caregiver the patient is in pain, informing the caregiver that the patient needs to use a restroom, requesting food, or requesting still other services or items. In some versions of patient support apparatus 20, assistance request control 126b may be adapted to allow a caregiver to make a request, either in addition to, or instead of, the patient. Indeed, in some versions of patient support apparatus 20, multiple assistance request controls 126b may be included on patient support apparatus 20, at least one of which is intended to be used by a patient and at least another of which is intended to be used by a caregiver. Such caregiver assistance request controls 126b may be used by the caregiver to indicate a code blue situation exists, to indicate that a patient's IV is empty or nearing empty, to request a cart, to request an exam kit, or to make other requests and/or indications.

In some versions of patient support apparatus 20, the purpose of assistance request control 126b is fixed and cannot be changed. In such versions, there is no need to include a dynamic label 146. Instead, a static label (not shown) may be used to indicate the purpose of assistance request control 126b.

In other versions of patient support apparatus 20, the purpose of assistance request control 126b may vary, and one or more triggering conditions may prompt a change in this purpose. Such triggering conditions may include, but are not limited to, any one or more of the following: movement of patient support apparatus 20 to a different location within the healthcare facility; changes in a particular time of day, day of week, day of the year, or other times; a particular diagnosis of the patient; the presence or absence of a caregiver adjacent patient support apparatus 20 (e.g. within the same room as patient support apparatus 20); the particular model and/or set of functionalities of patient support apparatus 20; and/or other conditions.

The presence/absence of a caregiver adjacent patient support apparatus 20 may be determined automatically by patient support apparatus 20 in a number of different manners. In one version, patient support apparatus 20 includes one or more ultra-wideband transceivers (not shown) that communicate with an ultra-wideband transceiver built into a caregiver's mobile phone or badge worn by the caregiver. The ultra-wideband transceivers range with each other and determine a distance between themselves. This distance determination indicates the closeness of the caregiver to patient support apparatus 20. Further details regarding the manner in which this distance may be determined are disclosed in the following commonly assigned patent applications: PCT application serial number PCT/US2023/026440 filed Jun. 28, 2023, by applicant Stryker Corporation and entitled BADGE AND PATIENT SUPPORT APPARATUS COMMUNICATION; PCT application serial number PCT/US2023/026462 filed Jun. 28, 2023, by applicant Stryker Corporation and entitled BADGE AND PATIENT SUPPORT APPARATUS COMMUNICATION; PCT application serial number PCT/US2023/026418 filed Jun. 28, 2023, by applicant Stryker Corporation and entitled BADGE AND PATIENT SUPPORT APPARATUS COMMUNICATION; U.S. application Ser. No. 63/565,946 filed Mar. 15, 2024, by inventor Kyle Thomas and entitled PATIENT SUPPORT APPARATUS WITH ENVIRONMENTAL INTERACTION, the complete disclosures of all of which are incorporated herein by reference. Other manners of determining the proximity of a caregiver (or their mobile device) to patient support apparatus 20 may also or alternatively be used, including, but not limited to, Bluetooth communications, conventional WiFi and access point 76 triangulation, conventional Real Time Location Systems (RTLS), and/or still other methods.

In some versions of patient support apparatus 20, controller 112 is configured to change the function of assistance request control 126b in response to the presence/absence of a nearby caregiver by changing the function of control 126b to a caregiver function when a caregiver is present and by changing the function of control 126b to a patient function when the caregiver is absent. Patient functions include requesting water (or another beverage), requesting ice or ice chips, informing a caregiver the patient is in pain, informing the caregiver that the patient needs to use a restroom, requesting food, or requesting still other services or items that the patient may need or desire. Caregiver functions include indicating that a code blue situation exists, indicating that a patient's IV is empty or nearing empty, requesting a cart, requesting an exam kit, or making other caregiver requests and/or informing other caregivers of other situations. Thus, in such versions, controller 112 automatically switches control 126b from performing a patient function to performing a caregiver function, and vice versa, based on the presence and absence of a nearby caregiver. In such versions, controller 112 automatically updates dynamic label 146 to indicate the currently implemented function so that the patient and/or caregiver knows the current purpose of assistance request control 126b.

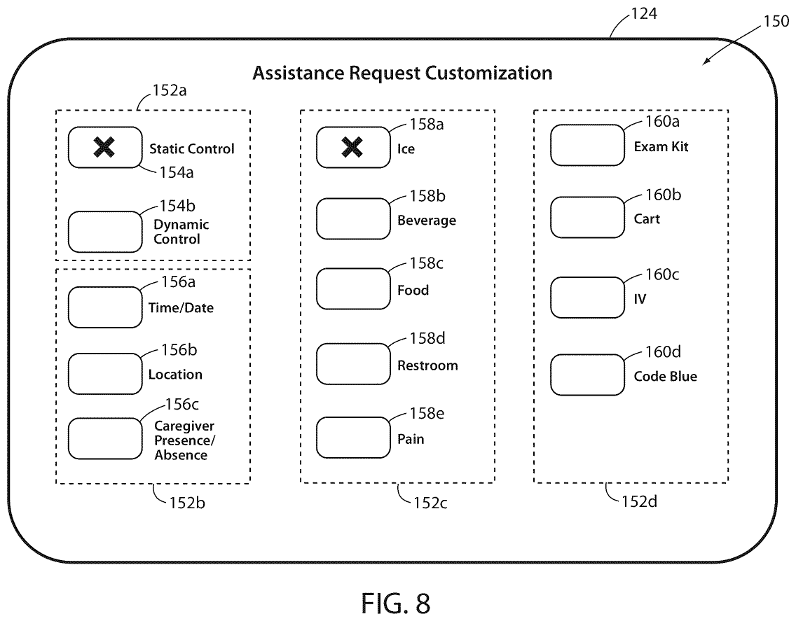

The choice of which patient function and/or which caregiver function to select for control 126b when a caregiver is present and when a caregiver is absent may be customized by the healthcare facility. That is, patient support apparatus 20 includes a customization screen 150 (FIG. 8) that is accessible to authorized personnel using control panel 48a or 48b, or in some versions, a remote electronic device (e.g. electronic device 162, a remote computer, etc.). Customization screen 150 may be displayed on display 124 of patient support apparatus 20, and display 124, in some versions, may be a touchscreen that allows the user to select different options on the customization screen 150. That is, customization screen 150 allows the authorized individual to select which function assistance request control 126b will perform when a caregiver is present and when a caregiver is absence, and/or which function is carried out in response to other triggering conditions, as well as still other selections.

As shown in FIG. 8, customization screen 150 includes four sets of customization options or functions 152a-d. Customization option 152a allows an authorized person to choose whether assistance request control 126b will be a dynamic control (i.e., one that changes) or a static control (i.e., one whose function does not change). Customization options 152b allow an authorized person to choose what triggering condition, or conditions, will be utilized by controller 112 when control 126b is a dynamic control. In other words, options 152b allow the user to customize what will cause the function of control 126b to change. Customization options 152c allow the user to select what patient functions may be implemented by control 126b, and customization options 152d allow the user to select what caregiver functions may be implemented by control 126b. Needless to say, triggering options 152b need not be displayed, or are otherwise rendered non-functional, if the user selects the “static” control 154a from amongst options 152a.

If the user selects static control 154a, the user may then select one of patient controls 158a-e or one of the caregiver controls 160a-d. In response to making that selection, controller 112 then assigns the selected function to assistance request control 126b. For example, if the user selects the ice control 158a, then controller 112 will treat assistance request control 126b as a control for the patient to use when requesting ice. If the user selects beverage control 158b, then controller 112 will treat assistance request control 126b as a control for the patient to use to request a beverage. Similarly, if the user selects any of the other patient controls 158c-e, or any of the caregiver controls 160a-d, controller 112 will treat assistance request control 126b as a control for the patient or caregiver to use to make the request corresponding to the selected control 158 or 160. In the situations where the user selects static control 154a, controller 112 will treat the assistance request control as carrying out the function selected by the user from controls 158 or 160, and this selected function will not change.

In situations where the user selects the dynamic control 126b, the user is then able to select one or more of the triggering condition options 152b, as well as one or more of the patient functions 152c or caregiver functions 152d. Controller 112 may be configured to change the content of customization screen 150 in response to the user selecting dynamic control 126b so that the user is able to select different functions for assistance request control 126b for different triggering conditions. Controller 112 may also be configured to change the content of customization screen 150 in response to the user selecting dynamic control 126b so that the user is able to select which first function assistance request control 126b carries out when the triggering condition occurs, and which second function assistance request control 126b carries out when the triggering condition does not occur. Thus, for example, the user may select time/date control 156a as one of the triggering condition options 152b. After making this selection, controller 112 allows the user to select the specific time and/or date that will correspond to the triggering condition. Further, after specifying the time and/or date of the triggering condition, controller 112 allows the user to select which one of the functions 152c or 152d control 126b will carry out during the specified time and/or date, and which one of the functions 152c or 152d control 126b will carry out at times other than the specified time or date.

Customization screen 150 therefore enables an authorized user to completely customize what function is carried out by assistance request control 126b when it is a static or dynamic control, what function it changes to carrying out in response to the existence of one or more triggering conditions when control 126b is a dynamic control, and what function it carries out in response to the non-existence of the one or more triggering conditions. Still further, customization screen 150 may allow the user to specify what function is carried out by assistance request control 126b in response to the presence of more than one triggering condition. That is, customization screen 150 may allow the user to specify not only what function assistance request control 126b performs in response to a single triggering condition, but what function it performs when there is any combination of two or more triggering conditions. In order to carry out these different selections, customization screen 150 may include one or more sub-menus and/or one or more additional screens that allow the user to specify the function of control 126b for the presence of each triggering condition and/or combination of triggering conditions, as well as the absence of each triggering condition and/or combination of triggering conditions.

It will, of course, be understood that the customization screen 150 shown in FIG. 8 is merely one example of the type of customization screen that may be displayed by controller 112. Controller 112 may be configured to display a customization screen 150 having different options 152a-d, different controls 154, 156, 158, and/or 160, and/or still other controls or options.

In order to restrict access to customization screen 150 to only authorized users, controller 112 may be configured to require a password, passcode, or other information to be entered by a user before granting access to screen 150. Alternatively, or additionally, patient support apparatus 20 may include one or more sensors that detect a badge, tag, or other device worn by authorized caregivers and, in response to the detection of a nearby badge, tag, or other device, allow access to customization screen 150, and in the absence of such detection, to disallow access to customization screen 150.

In some versions of patient support apparatus 20, controller 112 is configured to receive the selections a user makes using customization screen 150 from a remote device. That is, in some versions of patient support apparatus 20, a remote device—such as an electronic device 162, patient support apparatus server 78, remote server 84, or a computer in communication with either or both of servers 78 and/or 84—may be configured to display customization screen 150 on a display of that device, and thereby allow an authorized user to customize patient support apparatus 20 at a remote location. Once the user has made the desired selection on the remote customization screen 150, the remote device forwards these selections to patient support apparatus 20 through network 74 and network transceiver 118. When controller 112 receives these remote selections, it then implements them in the same manner as if the selections had been made by the user using a customization screen 150 displayed on display 124 of patient support apparatus 20. In some versions of patient support apparatus 20, controller 112 allows both local and remote customization screens 150 to be utilized by authorized personnel, while in other versions, only one of the remote or local customization screens may be implemented by authorized individuals.

As was mentioned previously, after an authorized user makes his or her desired selections using a local customization screen 150 or a remote customization screen 150, controller 112 is configured to update dynamic label 146 so that it matches the current function of assistance request control 126b. If the function of assistance request control 126b is a dynamic function, controller 112 is further adapted to update the dynamic label 146 in response to both the existence of the triggering condition(s), as well as the absence of the triggering condition(s). Thus, controller 112 is configured to update the dynamic label 146 so that it always matches whatever function assistance request control 126b is currently configured to carry out. Dynamic label 146 therefore informs the patient and/or caregiver of the current function of control 126b.

In some versions of patient support apparatus 20, the function carried out by assistance request control 126b is defined according to the customization data that a user enters into patient support apparatus 20 using customization screen 150 (whether locally or remotely displayed). In other versions of patient support apparatus, the function carried out by assistance request control 126b is defined according to the nurse call system 68 and data that the nurse call system 68 sends to patient support apparatus 20 through one or more pins 114 of wall outlet 60. In still other versions of patient support apparatus 20, the function carried out by assistance request control 126b may be defined by data received from both customization screen 150 and/or from the nurse call system 68. In still other versions, no data needs to be communicated to or from nurse call system 68 in order to define the function or functions carried out by assistance request control 126b.

When nurse call system 68 sends data to patient support apparatus 20 informing it of the function to be carried out by assistance request control, this data may be transmitted to patient support apparatus 20 via one of the pins 114 of wall outlet 60. In such scenarios, controller 112 is configured to decipher the data sent through the corresponding pin 114 and to change dynamic label 146 to match the function(s) specified by the nurse call system 68. In some situations, the data sent by nurse call system 68 may involve a simple change in the electrical state between a particular pair of pins 114, while in other cases the data sent may be sent as a serial stream of voltage changes over one or more pins 114 to patient support apparatus 20.

Still further, in some versions of patient support apparatus 20, controller 112 may be configured to send all or a portion of the customization data from customization screen 150 to nurse call system 68 so that nurse call system 68 knows the current function of assistance request control 126b. Such customization data may be sent through one or more specified pins 114. Alternatively, or additionally, controller 112 may be configured to carry out a negotiation with nurse call system 68 via one or more of the pins 114 wherein the negotiation leads to a settlement between patient support apparatus 20 and nurse call system 68 as to what function is to be carried out (and, in some cases, when that function is to be carried out) when a user activates assistance request control 126b. In some situations, the settlement may involve a set of functions that assistance request control 126b may carry out, and/or a manner in which controller 112 can specify to nurse call system 68 which function is currently being carried out by control 126b.

In some versions of patient support apparatus 20, nurse call system 68 needs to be informed of the function to be carried out by assistance request control 126b so that nurse call system 68 may appropriately react to the signal(s) conveyed to nurse call system 68 in response to the activation of assistance request control 126b. For example, if assistance request control 126b is currently configured to request ice when activated by the patient, nurse call system 68 will detect when an electrical change occurs on the one or more pins 114, as caused by nurse call interface 88 or 116, and nurse call system 68 will then have to react appropriately to this request for ice. The nurse call system 68, which may be a conventional nurse call system 68, may forward a communication to one or more caregivers, one or more dashboards, and/or to other devices indicating that the patient in a particular room has requested ice. The receiving device may then display a message corresponding to the current function of assistance request control 126b, such as, “Patient A is requesting ice,” or “Patient B needs to use the restroom,” etc. The forwarded communication may be in the form a text message, email, instant message, or another form.

In some situations, nurse call system 68 may be instructed to forward any requests is detects from assistance request control 126b to another server on network 74 and to let that server respond to the request. For example, in some situations, nurse call system 68 may be configured to forward any requests from assistance request control 126b to server 78 and/or remote server 84, and either or both of those servers may be programmed to respond appropriately to the request. In such situations, the purpose and/or function of the assistance request control 126b may be communicated to the server 78 and/or 84 from patient support apparatus 20, such as through one or more of the pins 114 and/or via network transceiver 118 (if present on patient support apparatus 20). Once server 78 and/or 84 receives the request, it may then forward a message to a caregiver badge, phone, dashboard, or other device that includes a message corresponding to the current function of assistance request control 126b, such as, “Patient A is requesting ice,” or “Patient B needs to use the restroom,” etc.

In some situations, in order for the nurse call system 68 to react properly to the activation of assistance request control 126b, one or more setup or configuration communications are carried out between patient support apparatus 20 and nurse call system 68 prior to the actual activation of assistance request control 126b. Such communications not only specify what function is to be carried out by assistance request control 126b, but may also specify any one or more of the following: what pin or pins 114 are to have their electrical state changed in response to activation of assistance request control 126b, what kind of electrical state change is to be implemented in response to the activation of assistance request control 126b, and, if the function of assistance request control 126b is to change, how that changed function will be communicated to nurse call system 68, as well as whether the pin or pins 114 will be changed in response to the changed function and/or whether the electrical state changes will be different in response to the changed function. In order to carry out such setup or configuration communications, one or more pieces of software and/or configuration settings of nurse call system 68 may need to be reprogrammed and/or changed, either manually or automatically. Such communications may take place through single changes of electrical states between one or more pins 114 of outlet 60, and/or they may take place through serial communication of multiple bits of data through one or more of pins 114.

When a patient or caregiver activates assistance request control 126b and assistance request control 126b is configured to carry out different functions according to one or more triggering conditions, controller 112 may be configured to react to the activation of assistance request control 126b in different manners. For example, if controller 112 changes an electrical state of a first pin 114 (or between a pair of pins 114) in response to activation of control 126b when it is to perform a first function, controller 112 may change the electrical state of the same first pin 114 (or pairs of pins 114) when control 126b is to perform a second and different function. That is, controller 112 may make electrical changes to the same pin 114, or pair of pins 114, when control 126b carries out a first function as it does when control 126b carries out a second function. In such situations, controller 112 may make different changes to the electrical state of the pin or pins 114 for the different function. Alternatively, or additionally, controller 112 may make the same electrical state change to the same pin or pins 114, but communicate that the function of control 126b has changed by utilizing communication over one or more other pins 114.

Alternatively, or additionally, controller 112 may be configured to make electrical changes to a different pin 114, or set of pins 114, in response to the function of assistance request control 126b changing. For example, if control 126b currently carries out a first function, controller 112 may change the electrical state between a first set of pins, and if control 126b subsequently changes to carrying out a second function, controller 112 may change the electrical state between a second set of pins 114 that are different from the first set of pins 114.

In summary, controller 112 may react to the changing function of assistance request control 126b by changing the choice of which pins 114 to make electrical changes to, or by changing the type of electrical changes that are made to pins 114, and/or by doing a combination of both. Nurse call system 68 may be informed, if appropriate, of how controller 112 will react during a configuration or setup process described above and carried out prior to activation of control 126b.

Although not shown in FIG. 6, patient support apparatus 20 may include a clock and/or calendar in order to monitor any triggering conditions that are based on time. Alternatively, or additionally, patient support apparatus 20 may determine the current time and/or date in any of the manners disclosed in commonly assigned U.S. Pat. No. 10,816,937 issued Oct. 27, 2020, to inventors Anuj K. Sidhu et al. and entitled PATIENT SUPPORT APPARATUSES WITH CLOCKS, the complete disclosure of which is incorporated herein by reference. Further, in order to carry out any functionality changes of assistance request control 126b that are based on location, controller 112 of patient support apparatus 20 may utilize a nearby wall unit 60 to determine the current location of patient support apparatus 20. Still other sensors may be included as part of patient support apparatus 20, or in communication therewith, for detecting other triggering conditions beyond the ones specifically mentioned herein.

The above-described patient support apparatus 20 enables a patient or caregiver to communicate requests to nurse call system 68 that were previously not allowed, other than through a verbal conversation with a remotely positioned caregiver. Patient support apparatus 20 allows these requests to be communicated electronically and routed to appropriate individuals, thereby helping to ensure that specific requests are routed to the particular caregivers responsible for carrying out such requests. Further, because such requests are carried out electronically, rather than by voice communication, it is not necessary for the recipient caregiver to interrupt their current task to talk to the person activating assistance request control 126b. He or she can simply check messages on their phone, badge, dashboard display, or other electronic device at an appropriate time. While providing this functionality, patient support apparatus 20 may still provide all of the conventional nurse call functionality of conventional patient support apparatuses, including nurse call control 126a. Further, the different functions of assistance request control 126b may be routed to different caregivers, depending upon the specific function, thereby allowing the patient (or other caregiver) to communicate directly with the appropriate responding person, which is different from prior art nurse call systems that route all call to the same recipient, regardless of the purpose of the call.

Patient support apparatus 20 may be utilized in different healthcare facilities, or locations within the same healthcare facility, in different manners. In a first manner, the communications between patient support apparatus 20 and nurse call system 68 with respect to one or more assistance request controls 126b are preconfigured. In a second manner, the communications between patient support apparatus 20 and nurse call system 68 with respect to one or more assistance request controls 126b are negotiated between patient support apparatus 20 and the nurse call system 68. With respect to the latter situation, a tech support team will configure the wall units and the nurse call system 68 (or a nurse call server) during installation of patient support apparatuses 20 (and/or wall units 60) such that, for that healthcare facility, the functions of one or more of the pins 114 are re-assigned from their conventional purpose to perform different requests. As but one example, the “Room Light” pin 114 (e.g. pin 3 of FIG. 11) could be re-purposed to behave as “patient with high level or pain” (or ice/water request). When that pin 114 is activated, a dashboard at one or more nurses' station 72 will then show the updated status to the caregiver. In order to allow multiple functionalities on the same pin, a code similar to morse code could be used on one pin 114 and mapped to different requests on the nurse call system 68.

In those situations where the communications between patient support apparatus 20 and the nurse call system are negotiated, patient support apparatus 20 and/or the nurse call system 68 are configured to support a common communication protocol or scheme over one or more pins 114 (e.g. CAN, Serial, I2C, etc.). This allows the patient support apparatus 20 and nurse call system 68 to negotiate custom pin functionalities dynamically and even have multiple alerts communicated through outlet 60. The wall unit 60 may, in some versions, initially transmit a “ping” request to the nurse call system over a specified pin 114 and await a response from nurse call system 68. When the wall unit 60 receives a valid response on the expected communication pin 114, it knows that the nurse call system 68 supports the same communication scheme and/or protocol. The patient support apparatus 20 and nurse call system 68 can thereafter negotiate one or more custom pin functionalities. This configuration can happen and be updated at any time.

Although FIG. 6 illustrates the assistance request control 126b integrated into the control panel 48c of patient support apparatus 20, it will be understood that, either in lieu of, or in addition to, control 126b integrated into control panel 48c, control 126b may be incorporated into a pendant or other device that is separate from patient support apparatus 20. The pendant or other device may be wirelessly coupled to patient support apparatus 20, or coupled by a cable or wire. In some versions, assistance request control 126b may be incorporated into a caregiver and/or patient's personal mobile phone, a caregiver's badge, and/or another portable device. Manners in which such portable devices may be used to control one or more functions of patient support apparatus 20 are disclosed in commonly assigned PCT/US2023/081094 filed Nov. 27, 2023, by applicant Stryker Corporation and entitled PATIENT SUPPORT APPARATUS COMMUNICATION SYSTEM, the complete disclosure of which is incorporated herein by reference.

The incorporation of assistance request control 126b into a mobile device (e.g., phone, badge, or other portable device) may refer to a dedicated physical control on the physical device, or it may refer to an icon or other control that is displayed on a display of the mobile device and that can be activated through conventional means (e.g. touching the control on a touch screen, clicking a computer mouse button while a cursor is over the control, etc.) When such an assistance request control 126b is incorporated into a mobile device, a software application on the mobile device instructs the mobile device to send a message to patient support apparatus 20 in response to activation of the control, and controller 112 responds to the message in the same manner as it responds to the activation of the assistance request control 126b onboard patient support apparatus 20, which has been previously described and need not be repeated herein. Further, controller 112 may be configured to send messages to the mobile device while it is in close proximity to patient support apparatus 20 (such as determined by UWB ranging) that indicate the current function of assistance request control 126b. In response to these messages, the mobile device software application may update the display of the assistance request control 126b on the display of the mobile device so that it matches the current function of the control 126b. In this manner, the user of the mobile device will know what function is carried out by the assistance request control 126b.

When a mobile device includes an assistance request control 126b, controller 112 may be configured to only act upon activation of the mobile device's assistance request control 126b if the mobile device is within a defined proximity to patient support apparatus 20, and to not act upon the activation of the mobile device's assistance request control 126b if the mobile device is not within the defined proximity to patient support apparatus 20. Such proximity determination may be carried out in any of the manners disclosed in the previously mentioned patent applications incorporated herein by reference, such as, but not limited to, the following: PCT application serial number PCT/US2023/026440 filed Jun. 28, 2023, by applicant Stryker Corporation and entitled BADGE AND PATIENT SUPPORT APPARATUS COMMUNICATION; PCT application serial number PCT/US2023/026462 filed Jun. 28, 2023, by applicant Stryker Corporation and entitled BADGE AND PATIENT SUPPORT APPARATUS COMMUNICATION; PCT application serial number PCT/US2023/026418 filed Jun. 28, 2023, by applicant Stryker Corporation and entitled BADGE AND PATIENT SUPPORT APPARATUS COMMUNICATION; U.S. application Ser. No. 63/565,946 filed Mar. 15, 2024, by inventor Kyle Thomas and entitled PATIENT SUPPORT APPARATUS WITH ENVIRONMENTAL INTERACTION; and PCT application serial number PCT/US2023/081094 filed Nov. 27, 2023, by applicant Stryker Corporation and entitled PATIENT SUPPORT APPARATUS COMMUNICATION SYSTEM, the complete disclosures of all of which are incorporated herein by reference.

In order to carry out one or more of the functionalities described herein, patient support apparatus 20 may include a plurality of relays, or other electronic switches, which can be coupled to different pins 114, depending upon the particular nurse call system 68 that is installed in a given healthcare facility. Such relays or switches are under the control of controller 112. In some versions, a circuit board on patient support apparatus 20 that is part of nurse call interface 88, and/or a circuit board on stationary unit 94 that is part of nurse call interface 116, can be designed to have multiple relays that are configurable so that the nurse call/audio/priority/assistance messages that are to be transmitted to the nurse call system 68 can be modified to match the particular nurse call system 68 installed within a particular healthcare facility. This helps achieve support for various nurse call system 68 brands/models and their corresponding pin allocations for nurse call/audio/priority/assistance requests.

It will be understood by those skilled in the art that the use of the term “transceiver” throughout this specification is not intended to be limited to devices in which a transmitter and receiver are necessarily within the same housing, or share some circuitry. Instead, the term “transceiver” is used broadly herein to refer to both structures in which circuitry is shared between the transmitter and receiver, and transmitter-receivers in which the transmitter and receiver do not share circuitry and/or a common housing. Thus, the term “transceiver” refers to any device having a transmitter component and a receiver component, regardless of whether the two components are a common entity, separate entities, or have some overlap in their structures.

Various additional alterations and changes beyond those already mentioned herein can be made to the above-described embodiments. This disclosure is presented for illustrative purposes and should not be interpreted as an exhaustive description of all embodiments or to limit the scope of the claims to the specific elements illustrated or described in connection with these embodiments. For example, and without limitation, any individual element(s) of the described embodiments may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Any reference to claim elements in the singular, for example, using the articles “a,” “an,” “the” or “said,” is not to be construed as limiting the element to the singular.

What is claimed is:

1. A patient support apparatus comprising:
a support surface adapted to support a patient thereon;
a nurse call interface adapted to communicatively couple to a multi-pin nurse call cable;
a nurse call control adapted to be activated by the patient in order to call a remote caregiver;
a second control adapted to be activated by at least one of the patient or a nearby caregiver in order to carry out a function different from calling the remote caregiver;
a controller adapted to change an electrical state of a first pin of the multi-pin nurse call cable in response to activation of the nurse call control, the controller further adapted to change an electrical state of a second pin of the multi-pin nurse call cable in response to activation of the second control, wherein the first pin is different from the second pin.

2. The patient support apparatus of claim 1 further including a dynamic label indicating the function of the second control, wherein the controller is adapted to change the dynamic label to indicate a different function for the second control.

3. The patient support apparatus of claim 2 wherein the dynamic label indicates that the second control is for at least one of the following: requesting a beverage, requesting ice, informing a caregiver the patient is in pain, indicating a code blue, indicating an IV is empty or nearing empty, requesting a cart, requesting an exam kit, informing the caregiver the patient needs to use a restroom, or requesting food.

4. The patient support apparatus of claim 1 wherein the controller is further adapted to communicate data over a third pin of the multi-pin nurse call cable with a nurse call system, wherein the data indicates the function of the second control, and the third pin is different from the first and second pins.

5. The patient support apparatus of claim 1 wherein the controller is further adapted to communicate data over a third pin of the multi-pin cable with a nurse call system, wherein the data indicates which pin of the multi-pin cable corresponds to the second pin, and the third pin is different from the first and second pins.

6. The patient support apparatus of claim 1 wherein:
the nurse call interface is adapted to electrically couple to a first end of the multi-pin nurse call cable, and a second end of the multi-pin nurse call cable is adapted to plug into a nurse call outlet defined in a room of a healthcare facility; and
the patient support apparatus further includes a microphone, and the controller is adapted to direct audio signals from the microphone to a third pin of the multi-pin nurse call cable, the third pin being different from both the first and second pins.

7. The patient support apparatus of claim 1 further including a dynamic label indicating the function of the second control, wherein the controller is adapted to change the dynamic label to indicate different functions of the second control in response to a triggering condition, wherein the triggering condition includes at least one of the following: a relocation of the patient support apparatus to a different location; a time of day; a day of the week; a day of the year; a diagnosis of the patient; a presence of a nearby caregiver; or an absence of a nearby caregiver.

8. A patient support apparatus comprising:
a support surface adapted to support a patient thereon;
a nurse call interface adapted to communicatively couple to a multi-pin nurse call cable;
a control adapted to be activated by at least one of the patient or a caregiver;
a dynamic label adapted to indicate a first function of the control; and
a controller adapted to change an electrical state of a first pin of the multi-pin nurse call cable in response to activation of the control, the controller further adapted to change the dynamic label to indicate a second function of the control in response to a triggering condition, wherein the second function is different from the first function.

9. The patient support apparatus of claim 8 wherein the triggering condition includes at least one of the following: a relocation of the patient support apparatus to a different location; a time of day; a day of the week; a day of the year; a diagnosis of the patient; a presence of a nearby caregiver; or an absence of a nearby caregiver.

10. The patient support apparatus of claim 8 wherein the second function includes at least one of the following: requesting a beverage, requesting ice, informing a caregiver the patient is in pain, indicating a code blue, indicating an IV is empty or nearing empty, requesting a cart, requesting an exam kit, informing the caregiver the patient needs to use a restroom, or requesting food.

11. The patient support apparatus of claim 8 wherein the dynamic label is displayed on a touchscreen display, and wherein the nurse call interface is adapted to electrically couple to a first end of the multi-pin nurse call cable, and a second end of the multi-pin nurse call cable is adapted to plug into a nurse call outlet defined in a room of a healthcare facility.

12. The patient support apparatus of claim 8 further including a microphone, and wherein the controller is adapted to direct audio signals from the microphone to a second pin of the multi-pin nurse call cable, the second pin being different from the first pin.

13. The patient support apparatus of claim 8 further including a nurse call control adapted to be activated by a patient of the patient support apparatus when the patient wishes to call a remote caregiver; and wherein the controller is adapted to change an electrical state of a second pin of the multi-pin nurse call cable in response to activation of the nurse call control, the second pin being different from the first pin.

14. The patient support apparatus of claim 13 wherein the controller is further adapted to communicate data over a third pin of the multi-pin nurse call cable with a nurse call system, the third pin being different from the first and second pins, and wherein the data includes at least one of the following: (a) an identification of the second function of the control; or (b) an identification of which pin of the multi-pin cable corresponds to the first pin.

15. The patient support apparatus of claim 13 further including a microphone, and wherein the controller is adapted to perform the following:
direct audio signals from the microphone to a third pin of the multi-pin nurse call cable, the third pin being different from the first and second pins;
communicate with the nurse call system via serial communication over a fourth pin of the multi-pin nurse call cable, the fourth pin being different the first, second, and third pins; and
communicate data defining the second function of the control via serial communication over the fourth pin.

16. A patient support apparatus comprising:
a support surface adapted to support a patient thereon;
a nurse call interface adapted to communicatively couple to a multi-pin nurse call cable;
a first control adapted to be activated by at least one of the patient or a caregiver in order to carry out a first function;
a second control adapted to be activated by at least one of the patient or the caregiver in order to carry out a second function different from the first function;
a controller adapted to change an electrical state of a first pin of the multi-pin nurse call cable in a first manner in response to activation of the first control, the controller further adapted to change the electrical state of the first pin in a second manner in response to activation of the second control, the first manner being different from the second manner.

17. The patient support apparatus of claim 16 wherein the first function includes at least one of the following: requesting a beverage, requesting ice, informing a caregiver the patient is in pain, indicating a code blue, indicating an IV is empty or nearing empty, requesting a cart, requesting an exam kit, informing the caregiver the patient needs to use a restroom, or requesting food.

18. The patient support apparatus of claim 16 wherein the first manner includes generating a first sequence of voltage changes on the first pin and the second manner includes generating a second sequence of voltage changes on the first pin, and the first sequence is different from the second sequence.

19. The patient support apparatus of claim 16 further including a microphone, and wherein the controller is adapted to direct audio signals from the microphone to a second pin of the multi-pin nurse call cable, the second pin being different from the first pin.

20. The patient support apparatus of claim 16 further including a sensor adapted to detect a state of a component of the patient support apparatus, and wherein the controller is further adapted to change an electrical state of a second pin of the multi-pin nurse call cable in response to the component changing from a first state to a second state.
